(19) United States
(12) Patent Application Publication
(10) Pub. No.: US 2023/0307918 A1
(43) Pub. Date: Sep. 28, 2023

(54) SYSTEM AND METHOD FOR BI-DIRECTIONAL DIRECT CURRENT CHARGING IN ELECTRIC VEHICLE SUPPLY EQUIPMENT

(71) Applicant: Enteligent Inc., Morgan Hill, CA (US)

(72) Inventors: Antonio Ginart, Santa Clara, CA (US); Bahman Sharifipour, Newington, NH (US); Sean Burke, Morgan Hill, CA (US); Brian Reeves, Hamilton (CA); Paul Reeves, 18305416 (CA); Wei Fan, Thornhill (CA); Julio Viola, La Paz (ER)

(21) Appl. No.: 18/305,416

(22) Filed: Apr. 24, 2023

Related U.S. Application Data
(63) Continuation-in-part of application No. 17/702,129, filed on Mar. 23, 2022.

(51) Int. Cl. H02J 3/32; H02M 3/335; H02J 7/00; H02J 3/38; H02J 7/35; B60L 53/63; B60L 53/50

(52) U.S. Cl. CPC H02J 3/322; H02M 3/33584; H02J 7/00032; H02J 3/381; H02J 7/0063; H02J 7/007; H02J 7/35; B60L 53/63; B60L 53/50; H02J 2207/20; H02J 2300/28; H02J 2300/24; B60L 2210/10

(57) ABSTRACT

A system and method for bi-directional direct current (DC) charging in electric vehicle supply equipment (EVSE) is disclosed. The system receives from power source managing subsystem, via plurality of power sources, electricity inputs corresponding to at least one of variable DC electricity input and relatively fixed DC input voltage comprising plurality of wide DC input voltage ranges. The system displays, via user interface associated with EVSE, selectable options to user. Further, system determines at least one of charging schema for charging operation, appropriate charging mode in plurality of charging modes, and discharging schema for the discharging operation using at least one of artificial intelligence (AI) techniques and machine learning (ML) techniques, based on power source information, and power demands. Further, the system executes, upon receiving the generated DC electricity, at least one of charging operation, appropriate charging mode, and discharging operation, based on power demands.

This application is a continuation-in-part of U.S. patent application Ser. No. 17/702,129, filed on Mar. 22, 2022, entitled “Electric Vehicle Solar Charging System,” which claims the benefit of U.S. Provisional patent application having Ser. No. 63/208,805, filed on Jun. 9, 2021, all of which are hereby incorporated by reference in their entirety.

### TECHNICAL FIELD

Embodiments of the present disclosure generally relate to managing electric energy flow or power among different electric energy sources for charging an electric vehicle and/or delivering power to one of the energy sources from one or more of the other energy sources, and/or delivering power to a house load from different electric energy sources, and more particularly to a system and a method for a bi-directional direct current (DC) charging/discharging in an electric vehicle supply equipment (EVSE).

### BACKGROUND

Generally, an electric vehicle supply equipment (EVSE) commonly referred to as charging stations, electric vehicle (EV) chargers, or charging docks supplies electricity to an electric vehicle (EV) for recharging one or more batteries in the EVs, plug-in hybrid EVs, and the like. Further, irrespective of charging the EV by an alternating current (AC) input or a direct current (DC) input, the most prevalent type of EVSE is usually powered by the AC input. The AC input may include an AC level 1 input and AC level 2 input, where the EVSEs are installed in a residential and/or a low-charging rate commercial/public location. The AC level 1 based EVSE may be the slowest equipment, which provides charging through a common residential 120-volt (120V) AC outlet. Level 1 chargers can take 40-50 hours to charge a battery electric vehicle (BEV) from empty and 5-6 hours to charge a plug-in hybrid electric vehicle (PHEV) from empty. As with level 1 AC charging, with level 2 charging, the AC input is delivered to the EV where it is converted to DC power for charging the EV batteries. This class of charger is lower in cost and easier to connect to your building's existing electrical infrastructure than DC (level 3) chargers. Furthermore, DC (level 3) based EVSEs are almost exclusively installed in commercial/public fast charging locations. However, the DC based EVSEs are powered by the AC input, anywhere from 2240V AC single phase to 480V AC three phase and beyond. The range of these voltage inputs usually conforms with standard electrical ranges.

Conventionally, there are examples of the EVSEs powered by the DC input; however, the DC input based EVSEs have been limited to (relatively) low-voltage service vehicle applications, where the DC input is within a tight fixed range. In addition, the DC input based EVSEs have limited to no interaction as to directing from where their power source(s) originate. The origin(s) of the electricity is agnostic to the EVSEs. Further, while some conventional systems may incorporate an electric vehicle charging system comprising a DC photovoltaic (PV) source or a DC source to transmit DC electricity to the EV via a DC-DC conversion system, they may not receive variable DC voltages from multiple power/energy sources for fulfilling power demands and for cost-effectively delivering power. Further, the conventional systems may not optimize for power arbitration of power input and/or output, for cost saving in a house load, for orchestrating differing power inputs for EV not fast charging, green charging and economy charging scenarios, and the like.

Hence, there is a need for an improved system and method for a bi-directional direct current (DC) charging in an electric vehicle supply equipment (EVSE), to address at least the aforementioned issues/problems in the existing approaches.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure includes a system for a bi-directional direct current (DC) charging in an electric vehicle supply equipment (EVSE). The system comprises a bi-directional direct current DC-to-DC conversion subsystem, which may be communicatively coupled to a power source managing subsystem. The system receives from the power source managing subsystem, via a plurality of power sources, one or more electricity inputs corresponding to at least one of a variable DC electricity input and a relatively fixed DC input voltage comprising a plurality of wide DC input voltage ranges. Further, the system transmits power source information to an electric vehicle supply equipment (EVSE), based on receiving the one or more electricity inputs. Furthermore, the system receives a connection request from the EVSE to connect to the plurality of power sources for receiving one or more electricity inputs, based on the power source information. The connection request comprises at least one of a required one or more electricity inputs from the plurality of power sources and a required voltage for one or more power demands by one or more power-demanding equipment. Additionally, the system connects to the plurality of power sources for receiving the one or more electricity inputs, based on the received connection request from the EVSE. Further, the system generates, using one or more bi-directional DC-DC converters, converted DC electricity by adjusting the received one or more electricity inputs to a necessary voltage for one or more power demands.

Further, the system comprises the EVSE, communicatively coupled to the bi-directional DC-DC conversion subsystem. The system displays, via a user interface associated with the EVSE, one or more selectable options to a user. The one or more selectable options comprise at least one of a charging operation, a discharging operation, and a plurality of charging modes. Further, the system determines, in response to a selected one or more selectable options, at least one of a charging schema for the charging operation, an appropriate charging mode in the plurality of charging modes, and a discharging schema for the discharging operation using at least one of one or more artificial intelligence (AI) techniques and one or more machine learning (ML) techniques, based on the power source information, and the one or more power demands.

Furthermore, the system transmits, upon receiving the power source information from the bi-directional DC-DC conversion subsystem, the connection request to the bi-directional DC-DC conversion subsystem, based on the determined at least one of the charging schema, the appropriate charging mode, and the discharging schema. Additionally, the system receives, in response to the connection request, the generated DC electricity from the bi-directional DC-DC conversion subsystem, based on the determined at least one of the charging schema, the appropriate charging mode, and the discharging schema. Further, the system executes, upon receiving the generated DC electricity, at least one of the charging operations, the appropriate charging mode, and the discharging operation, based on the one or more power demands.

Another aspect of the present disclosure includes a method for a bi-directional direct current (DC) charging in an electric vehicle supply equipment (EVSE). The method includes receiving, via a plurality of power sources, one or more electricity inputs corresponding to at least one of a variable DC electricity input and a relatively fixed DC input voltage comprising a plurality of wide DC input voltage ranges. Further, the method includes transmitting power source information to an electric vehicle supply equipment (EVSE), based on receiving the one or more electricity inputs. Furthermore, the method includes receiving a connection request from the EVSE to connect to the plurality of power sources for receiving one or more electricity inputs, based on the power source information. The connection request comprises at least one of a required one or more electricity inputs from the plurality of power sources and a required voltage for one or more power demands by one or more power demanding equipment. Additionally, the method includes connecting to the plurality of power sources for receiving the one or more electricity inputs, based on the received connection request from the EVSE. Further, the method includes generating using one or more bi-directional DC-DC converters, a converted DC electricity by adjusting the received one or more electricity inputs to a necessary voltage for one or more power demands.

Further, the method includes displaying one or more selectable options to a user. The one or more selectable options comprises at least one of a charging operation, a discharging operation, and a plurality of charging modes. Furthermore, the method includes determining, in response to a selected one or more selectable options, at least one of a charging schema for the charging operation, an appropriate charging mode in the plurality of charging modes, and a discharging schema for the discharging operation using at least one of one or more artificial intelligence (AI) techniques and one or more machine learning (ML) techniques, based on the power source information and the one or more power demands. The appropriate charging mode is determined based on the power source information. Additionally, the method includes transmitting, upon receiving the power source information from the bi-directional DC-DC conversion subsystem, the connection request to the bi-directional DC-DC conversion subsystem, based on the determined at least one of the charging schema, the appropriate charging mode, and the discharging schema. Further, the method includes receiving, in response to the connection request, the generated DC electricity from the bi-directional DC-DC conversion subsystem, based on the determined at least one of the charging schema, the appropriate charging mode, and the discharging schema. Furthermore, the method includes executing, upon receiving the generated DC electricity, at least one of the charging operation, the appropriate charging mode, and the discharging operation, based on the one or more power demands.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an exemplary block diagram representation of a network architecture for a system for a bi-directional direct current (DC) charging in an electric vehicle supply equipment (EVSE), in accordance with an embodiment of the present disclosure;

FIGS. 2A-2C illustrate exemplary circuit diagram representations of one or more DC-DC converters, in accordance with an embodiment of the present disclosure;

FIG. 3A illustrates an exemplary flow diagram representation of a prediction method and a planning method by an electric vehicle supply equipment (EVSE), in accordance with an embodiment of the present disclosure;

FIG. 3B illustrates an exemplary graph diagram representation of a prediction, planning, and a cost saving approach using a planning model (no EV connected scenario) for an exemplary 12-hour scenario, in accordance with an embodiment of the present disclosure;

FIG. 3C illustrates an exemplary graph diagram representation of a cost saving scenario using the planning model 304 (no EV connected) for a long term, in accordance with an embodiment of the present disclosure;

FIG. 3D illustrates an exemplary graph diagram representation of an energy arbitrage scenario with planning (no EV connected) scenario, in accordance with an embodiment of the present disclosure;

FIG. 4A illustrates an exemplary schematic representation of an energy storage subsystem (ESS) battery-enabled energy saving/arbitration scenario, in which a battery charging/discharging schema is implemented based on a situation, in accordance with an embodiment of the present disclosure;

FIG. 4B illustrates an exemplary tabular representation of one or more parameters for a PV-ESS-grid-load, in accordance with an embodiment of the present disclosure;

FIG. 5A illustrates an exemplary graphical representation of EV connection time in day distribution, in accordance with an embodiment of the present disclosure;

FIG. 5B illustrates an exemplary graphical representation of required charging speed/kw, in accordance with an embodiment of the present disclosure;

FIG. 5C illustrates an exemplary graphical representation of a state of the ESS battery impacting the charging performance when meeting the charging demand in required time, in accordance with an embodiment of the present disclosure;

FIG. 5D illustrates an exemplary graphical representation of state of the ESS battery impacting the charging performance when energy being charged within required time compared to required amount is not meeting a requirement, in accordance with an embodiment of the present disclosure;

FIG. 5E illustrates an exemplary graphical representation of average charging speed (kw) during the charging events, in accordance with an embodiment of the present disclosure;

FIG. 5F illustrates an exemplary graphical representation of a fast EV charging scenario, in accordance with an embodiment of the present disclosure;

FIG. 6A illustrates an exemplary timing diagram representation of a charging event during load scheduling for economical charging policy, in accordance with an embodiment of the present disclosure;

FIG. 6B illustrates an exemplary graphical diagram representation of ECO charging meeting various charging speed demands, in accordance with an embodiment of the present disclosure;

FIG. 6C illustrates an exemplary graphical diagram representation of a comparative study charging demand suitable for an ECO policy/mode, in accordance with an embodiment of the present disclosure;

FIG. 6D illustrates an exemplary graphical diagram representation depicting a ECO and FAST charging cost, and grid-stress comparison, in accordance with an embodiment of the present disclosure;

FIGS. 6E and 6F illustrate exemplary graphical diagram representations of grid supply power (/kw) during FAST and ECO charging, in accordance with an embodiment of the present disclosure; and

FIG. 7 illustrates an exemplary flow diagram representation of a method for a bi-directional direct current (DC) charging in an electric vehicle supply equipment (EVSE), in accordance with an embodiment of the present disclosure; and

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one example of a particular element. The terms “a” and “an” may also denote more than one example of a particular element. In the following specification and the claims, reference will be made to a number of terms, which shall be defined to have the following meanings. The singular forms “a”, “an”, and “the” include plural references unless the context clearly dictates otherwise.

As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered. The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Unless otherwise defined, all technical and scientific terms used herein have the same meaning as commonly understood by those skilled in the art to which this disclosure belongs. The system, methods, and examples provided herein are only illustrative and not intended to be limiting.

Various embodiments of the present disclosure provide a system and a method for a bi-directional direct current (DC) charging in an electric vehicle supply equipment (EVSE). In general, the embodiments provided herein relate to managing electric energy flow or power among different electric energy sources, for charging an electric vehicle and/or delivering power to one of the energy sources from one or more of the other energy sources, and/or delivering power to a house load from different electric energy sources. The present disclosure provides a system and method for accepting a variable DC voltage input rather than a fixed DC voltage input. The variable DC voltage input can vary over time or can accept a relatively fixed DC input with a wide range of input DC voltages, or both. The present disclosure provides a system and a method for adjusting, by an electric vehicle supply equipment (EVSE), the voltage internally to meet the charge voltage(s) supported by any respective connected electric vehicle (EV) or a house load. The present disclosure allows the user to interact with the EVSE to select from what sources and when charging/discharging would take place, and these selections can be communicated to a power source managing subsystem. These control selections can include power source(s), time to start charge, time by which to finish charge, et cetera. These types of control selections can provide different charging modes which are selectable by the individual with the EVSE, either directly or by a communicating software application. The present disclosure optimizes charging load scheduling based on a grid price. The present disclosure ensures planning the charging and ensures the target is met in desired time. The present disclosure minimizes the charging cost, especially when there are grid price changes during some time of the day. Further, the present disclosure ensures planning of a typical strategy for (a photovoltaic (PV)-grid—energy storage subsystem (ESS)-house load) system scenario.

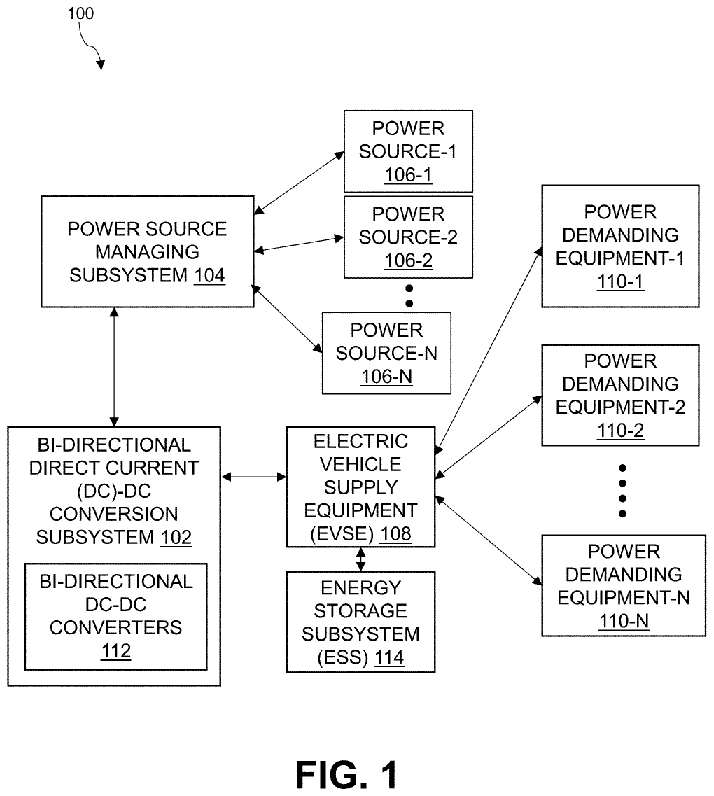

FIG. 1 illustrates an exemplary block diagram representation of a network architecture for a system 100 for a bi-directional direct current (DC) charging in an electric vehicle supply equipment (EVSE) 108, in accordance with an embodiment of the present disclosure. The network architecture may include the system 100, a bi-directional direct current (DC)-to-DC conversion subsystem 102, a power source managing subsystem 104, a plurality of power sources 106-1, 106-2, . . . , 106-N (collectively referred to as the power sources 106 and individually referred to as the power source 106), an electric vehicle supply equipment (EVSE) 108, one or more power demanding equipment 110-1, 110-2, 110-N (collectively referred to as the power demanding equipment 110 and individually referred to as the power demanding equipment 110), one or more bi-directional DC-DC converters 112 associated with the bi-directional DC-DC conversion subsystem 102, and an energy storage subsystem (ESS) 114. Though few components and subsystems are disclosed in FIG. 1, there may be additional components and subsystems which is not shown, such as, but not limited to, converters, limiters, filters, controllers, suppressors, inverters, rectifiers, voltage down graders, voltage up graders, switches, displays, user interfaces, buttons, sockets, plugs, input and output ports, battery management subsystems, processors, and the like. The person skilled in the art should not be limiting the components/subsystems shown in FIG. 1.

The system 100, including one or more power sources 106 may transmit power (in the form of direct current (DC)) either directly or round-trip through the EVSE 108, or a combination of both, to an electric vehicle (EV) (not shown in FIGs.) via the EVSE 108. In some embodiments, the DC/DC converters 112 may not be required if a hybrid PV inverter's DC input/output delivers power directly at a desired fixed current. The ESS 114 may be electrically connected to the bi-directional DC-DC conversion subsystem 102. In some embodiments, the bi-directional DC-DC converters 112 is bidirectional and configured to generate one or more output current, when the system 100 is in a charging operation or a discharging operation. Further, the EVSE 108 may include one or more processors to perform one or more operations described below.

The voltages from the plurality of power sources 106 are adjusted to a matched constant voltage (for example, between 420 and 380 V DC) through the bi-directional DC-DC conversion subsystem 102, as necessary, depending on the origin voltage of each of the plurality of power sources 106. The output of the bi-directional DC-DC conversion subsystem 102 may be adjusted to match a desired voltage communicated by one or more power demands of the power demanding equipment 110-1, which may be different for different power demanding equipment 110-1.

Alternatively, the bi-directional DC-DC conversion subsystem 102 may adjust a variable DC input from the plurality of power sources 106, to match the voltage desired by the EV, which also may be bi-directional to return power from the ESS 114 into the house load if desired (e.g., for emergency power use during a grid outage, or for peak grid-management by the power utility, and cost optimization).

In an exemplary embodiment, the bi-directional DC-DC conversion subsystem 102 may be communicatively coupled to the power source managing subsystem 104. In an exemplary embodiment, the system 100 may execute the bi-directional DC-DC conversion subsystem 102 to receive from the power source managing subsystem 104, via the plurality of power sources 106, one or more electricity inputs corresponding to at least one of a variable DC electricity input and a relatively fixed DC input voltage comprising a plurality of wide DC input voltage ranges. In an exemplary embodiment, the plurality of power sources 106 include, but are not limited to, a breaker-box connected to an electricity grid, and the like, one or more energy storage subsystem (ESS) sources comprising, but not limited to, one or more electro-chemical batteries, a kinetic storage, a gravitational storage, and the like, one or more renewable energy sources comprising, but not limited to, a photovoltaic (PV) solar energy source, a wind energy source, and the like.

In an exemplary embodiment, the system 100 may execute the bi-directional DC-DC conversion subsystem 102 to transmit power source information to the EVSE 108, based on receiving the one or more electricity inputs. In an exemplary embodiment, the power source information includes, but not limited to, a type of each of the plurality of power sources, one or more electricity inputs received from each of the plurality of power sources, one or more voltage ranges of the one or more electricity inputs, a capacity of each of the plurality of power sources, other loads which are supplied by the power source managing subsystem, current and future power pricing data, electrical grid demand response data, current or future power source capacity data, and the like. For example, the electrical grid demand response or demand response may be a program that incentivizes consumers to reduce or shift their electricity usage during peak periods, which can help balance the supply and demand of the electric grid. This can lead to lower costs in wholesale and retail markets. Methods of engaging customers include time-based rates and direct load control programs, which allow power companies to cycle appliances on and off during peak demand in exchange for financial incentives and lower bills.

In an exemplary embodiment, the system 100 may execute the bi-directional DC-DC conversion subsystem 102 to receive a connection request from the EVSE 108 to connect to the plurality of power sources 106 for receiving one or more electricity inputs, based on the power source information. In an exemplary embodiment, the connection request includes, but is not limited to, a required one or more electricity inputs from the plurality of power sources, a required voltage for one or more power demands by one or more power demanding equipment, and the like.

In an exemplary embodiment, the system 100 may execute the bi-directional DC-DC conversion subsystem 102 to connect to the plurality of power sources 106 for receiving the one or more electricity inputs, based on the received connection request from the EVSE 108.

In an exemplary embodiment, the system 100 may execute the bi-directional DC-DC conversion subsystem 102 to generate, using one or more bi-directional DC-DC converters 112, a converted DC electricity by adjusting the received one or more electricity inputs to a necessary voltage for one or more power demands. In an exemplary embodiment, the one or more bi-directional DC-DC converters 112 include, but not limited to, a capacitor-inductor-inductor-capacitor (CLLC) based DC-DC converter, a capacitor-inductor-inductor-inductor-capacitor (CLLLC) based DC-DC converter, a dual active bridge (DAB) based DC-DC converter, a buck based DC-DC converter, a buck-boost based DC-DC converter, a power factor correction (PFC) inverter based DC-DC converter, a PFC rectifier based DC-DC converter, an electromagnetic interference (EMI) filter based DC-DC converter, and the like.

In an exemplary embodiment, the EVSE 108 may be communicatively coupled to the bi-directional DC-DC conversion subsystem 102. In an exemplary embodiment, the system 100 may execute the EVSE 108 to display, via a user interface (not shown) associated with the EVSE 108, one or more selectable options to a user (not shown). In an exemplary embodiment, the one or more selectable options include, but are not limited to, a charging operation, a discharging operation, a plurality of charging modes, and the like. In an exemplary embodiment, the one or more selectable options further comprise, but not limited to, a preference of each of the plurality of power sources, a period of charging operation, a period of discharging operation, and the like. In an exemplary embodiment, the charging operation includes, but not limited to, charging a battery pack configured to power an electric vehicle (EV), charging an energy storage unit associated with an energy storage subsystem (ESS) communicatively coupled to the EVSE, based on the charging schema, and the like. In an exemplary embodiment, the discharging operation includes, but not limited to, discharging the energy storage associated with the ESS to power a house load, based on the discharging schema, and the like. In an exemplary embodiment, the plurality of charging modes may be used for charging the battery pack configured to power the electric vehicle (EV). In an exemplary embodiment, the plurality of charging modes includes at least one of a renewable charging mode, a green charging mode, a fast-charging mode, an economy charging mode, a time-based charging mode, a capacity-based charging mode, and the like.

In an exemplary embodiment, the renewable charging mode uses one or more available renewable energy sources from the plurality of power sources. In an exemplary embodiment, the green charging mode uses at least one of the one or more renewable energy sources and one or more energy storage subsystem (ESS) sources. In an exemplary embodiment, the fast-charging mode uses maximum energy from each of the plurality of power sources to charge the EV in a short period. In an exemplary embodiment, the economy charging mode is used for the charging operation based on the lowest energy cost mixture of the plurality of power sources. In an exemplary embodiment, the time-based charging mode uses an efficient and cost-effective power sources to charge the EV to a certain capacity by a certain time. In an exemplary embodiment, the capacity-based charging mode uses an efficient and cost-effective power source to charge the EV to a pre-determined capacity.

In an exemplary embodiment, the system 100 may execute the EVSE 108 to determine, in response to a selected one or more selectable options, at least one of a charging schema for the charging operation, an appropriate charging mode in the plurality of charging modes, and a discharging schema for the discharging operation using at least one of one or more artificial intelligence (AI) techniques and one or more machine learning (ML) techniques, based on the power source information, and the one or more power demands. In an exemplary embodiment, the appropriate charging mode may be determined based on the power source information. For example, the charging scheme for EV charging operations may include charging the EV battery as quickly as possible using both grid AC input and energy stored in the ESS battery. Alternatively, the grid AC charging can be delayed until electricity prices decrease according to the pricing schedule. Other possible charging schemes may include, but are not limited to, a sequence of different operations based on conditions such as pricing, storage availability, and the like.

In an exemplary embodiment, the system 100 may execute the EVSE 108 to transmit, upon receiving the power source information from the bi-directional DC-DC conversion subsystem 102, the connection request to the bi-directional DC-DC conversion subsystem 102, based on the determined at least one of the charging schema, the appropriate charging mode, and the discharging schema.

In an exemplary embodiment, the system 100 may execute the EVSE 108 to receive, in response to the connection request, the generated DC electricity from the bi-directional DC-DC conversion subsystem 102, based on the determined at least one of the charging schemas, the appropriate charging mode, and the discharging schema.

In an exemplary embodiment, the system 100 may execute the EVSE 108 to execute, upon receiving the generated DC electricity, at least one of the charging operations, the appropriate charging mode, and the discharging operation, based on the one or more power demands.

In an exemplary embodiment, the ESS 114 may be communicatively coupled to the EVSE 108. In an exemplary embodiment, the system 100 may execute the ESS 114 to receive at least one of one or more energy inputs from one or more energy sources and the one or more electricity inputs form the plurality of power sources 106, based on the charging schema. In an exemplary embodiment, the system 100 may execute the ESS 114 to store the received at least one of the one or more energy inputs and the one or more electricity inputs. In an exemplary embodiment, the system 100 may execute the ESS 114 to transmit to the EVSE 108, the stored at least one of the one or more energy inputs and the one or more electricity inputs, based on the discharging schema.

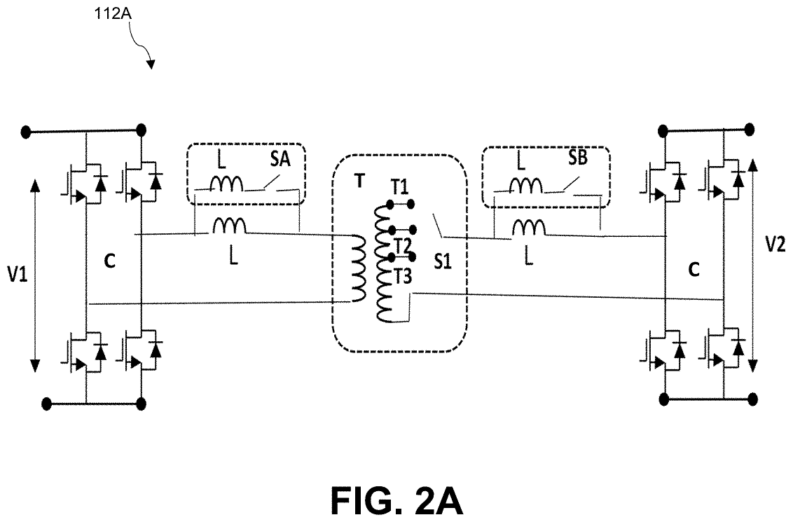

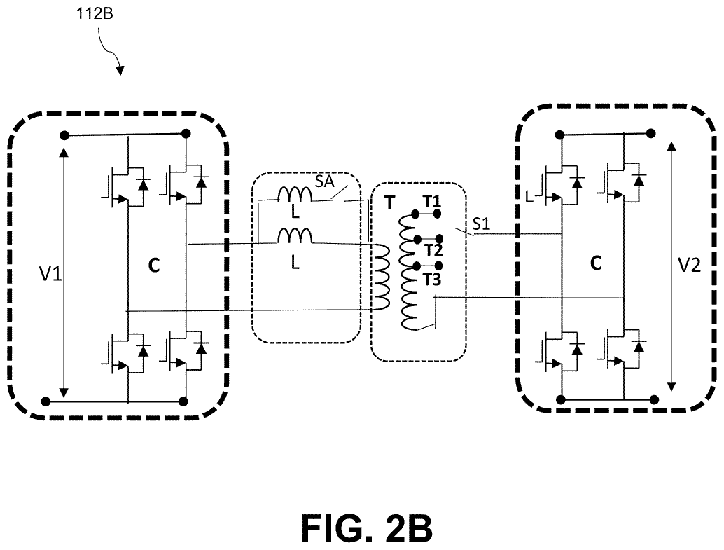

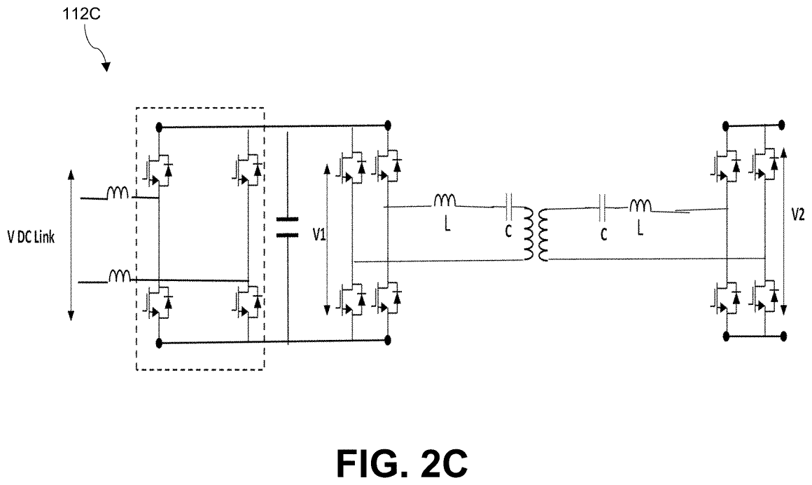

FIGS. 2A-2C illustrate exemplary circuit diagram representations of one or more DC-DC converters 112A-112C, in accordance with an embodiment of the present disclosure. FIG. 2A illustrates an exemplary circuit diagram representation of a bidirectional DC-DC converter 112A based on a capacitor-inductor-inductor-capacitor (CLLC) topology. The CLLC topology may enable highly efficient DC-DC energy conversion by producing switching at voltage and current at or near zero based on a resonant point. To mitigate a very narrow range of operation of the CLLC topology-based bidirectional DC-DC converter 112A, a variable transformer ‘T’ may be implemented in combination with a variable inductor 1′ arrangement that adapts the output voltage range to the EV battery. Adapting the output voltage range to the EV battery may be based on selecting the appropriate/optimal taps (T1, T2, T3) combinations of the variable transformer ‘T’. The appropriate transformer taps (T1, T2, T3, TN) may be selected using a negotiation protocol that determines the type and stage of charge of the vehicle or storage battery. The output of the bidirectional DC-DC converter 112A may be based on a smart, trained AI algorithm to pre-determine a number and sequence of topologies based on the vehicle-battery type, DC voltage condition, and a state of charge (SoC). Further, FIG. 2A illustrates the switches (solid state or electromechanical) ‘SA’, ‘SB’, and ‘S1’, that operate for a particular stage and can change one or more input/output voltages (V1/V2) while maintaining a high degree of energy conversion efficiency, because the switching occurs close to the proper resonant condition. Among the possible combinations, a switch ‘S1’ may select any of the transformer taps (T1, T2, T3, . . . , TN) in combination with opening or closing the switches SA, SB, SN associated with the inductor ‘L’.

FIG. 2B illustrates an exemplary circuit diagram representation of a wide-range double active bridge (DAB) DC-DC converter 112B. A digital-to-analog converter (DAC) may operate based on the principle of “soft switching” by “phase shifting” the voltage and current during switching. This involves closing the devices that have already reached voltage zero, which significantly reduces EMI emissions and switching power losses. The DAB may include a wider range of soft switching operation than CLLC converters. The DAB may be highly controllable because, outside of the soft switching, as the DAB may continue to operate at hard switching mode. Further, the DAC when operated at the hard switching mode similar to all hard switching techniques, the DAC may generate a large amount of losses to an electromagnetic interference (EMI). To keep the DAB in soft switching such as the CLLC converters, a transformer with a tap and an arrangement of variable common mode choke may be implemented to the DAB. When operated in an appropriate way, the transformer with the tap and an arrangement of variable common mode choke enables the DAB to function in a large range with soft switching mode. In the condition described above, the DAB DC-DC converter may deliver a large range of variation input and output voltages (V1/V2) at a low EMI and low switching losses. The DAB DC-DC converter 112B may require a trained AI algorithm to pre-determine the sequences of switches, SA, SB, SN, and S1.

FIG. 2C illustrates an exemplary circuit diagram of a buck/boost-based DC-DC converter 112C. Front end buck/boost-based DC-DC converter may provide variation of the voltages. The buck/boost-based technique may deal with the low efficiency, due to multi-stage approach and very high EMI of the hard switching. The restriction direct current voltage (VDC) link may be restricted that the VDC may need to be lower than V1.

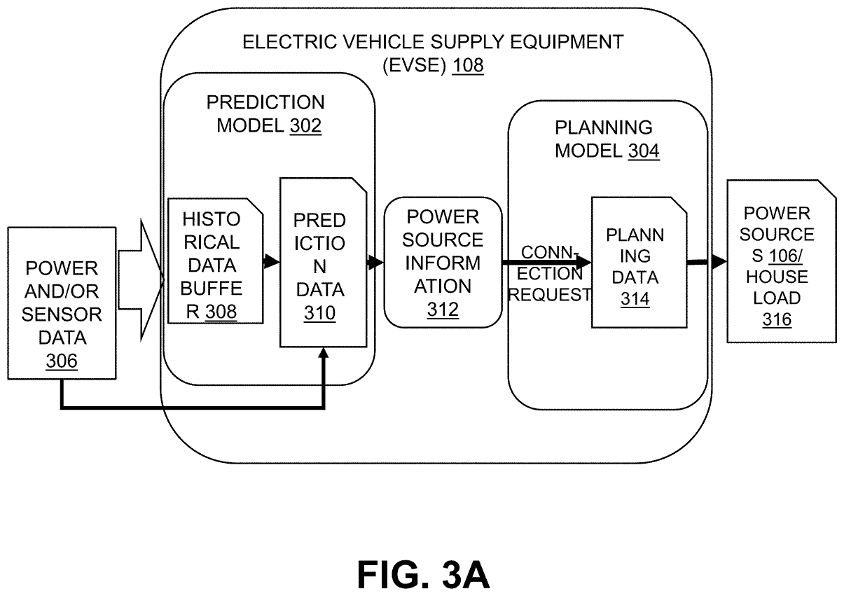

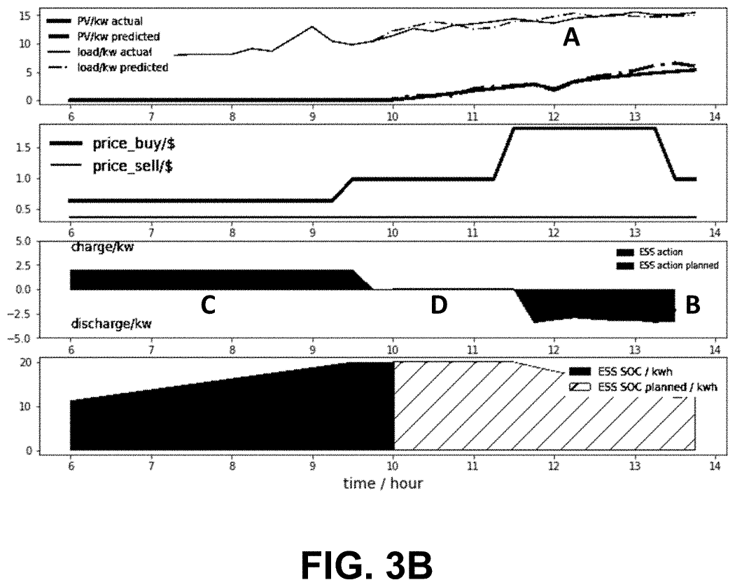

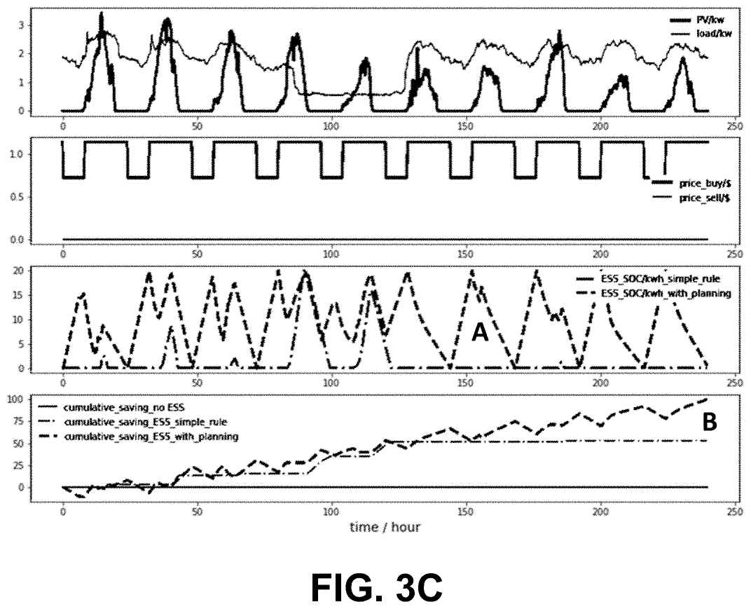

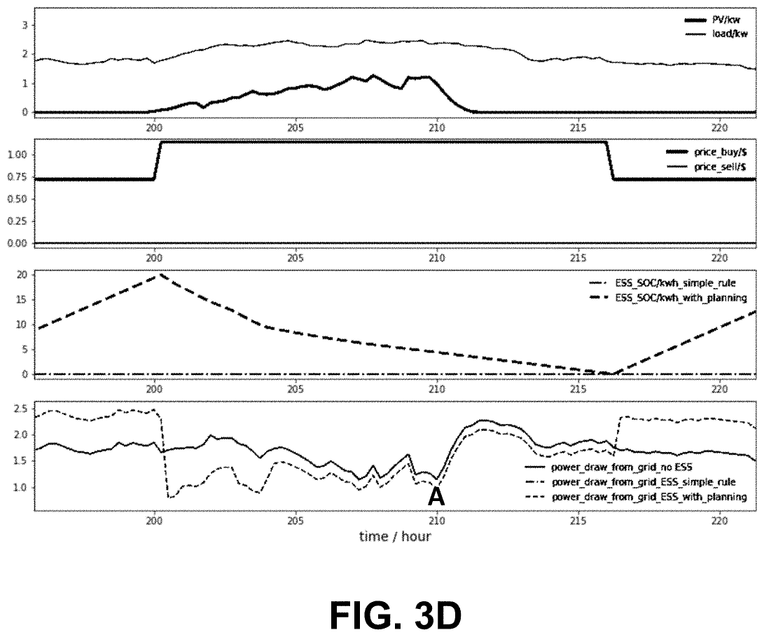

FIG. 3A illustrates an exemplary flow diagram representation of a prediction method and a planning method by an electric vehicle supply equipment (EVSE) 108, in accordance with an embodiment of the present disclosure.

In an exemplary embodiment, the model-predictive control method may be chosen to be a main framework of a prediction model 302 associated with the EVSE 108. The EVSE 108 may solve prediction/planning problem by using prediction models and controls on model prediction. By decoupling the two models such as the prediction model 302 and planning model 304, the EVSE 108 may iterate each of them separately at a faster pace. Further, the EVSE 108 may include good adaptivity as a rolling-optimization procedure, suitable for this sequential action optimization problem. The EVSE 108 may find an optimal solution (an action sequence) in the receding future horizon and takes the first action for current time to operate. The EVSE 108 may then solve a new set of adaptions with updated states/predictions using real-time feedback, which has good adaptivity to any changes in the predicted variables/environment parameters. The EVSE 108 may optimize problems in a progressing horizon.

### Prediction Model 302:

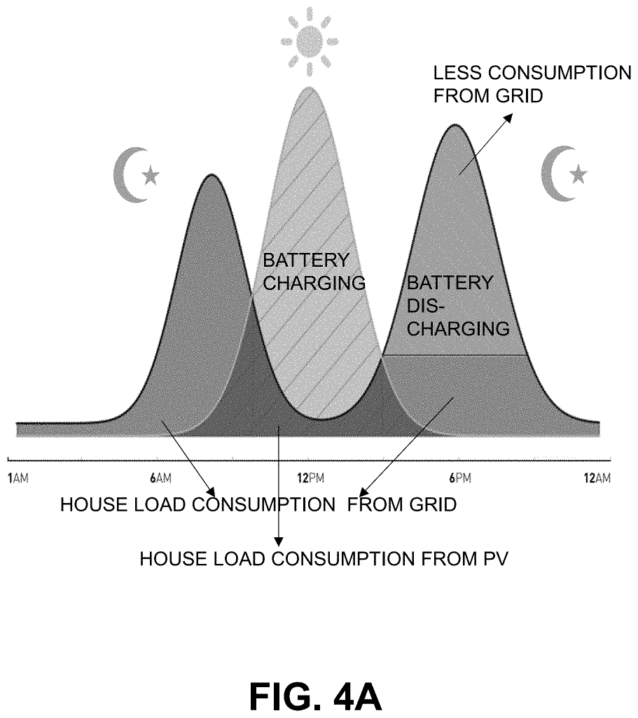

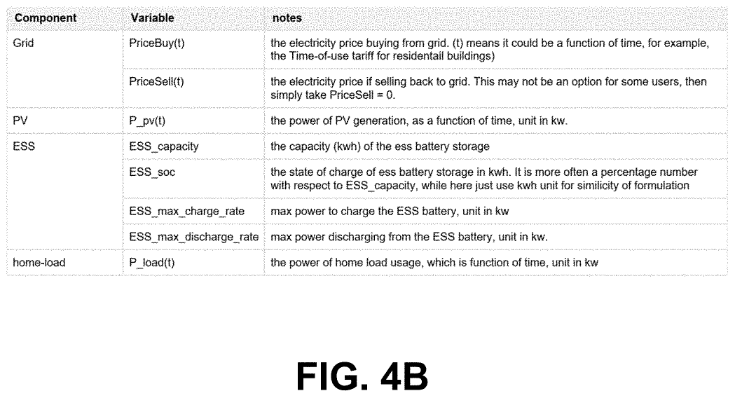

The prediction model 302 may record and store a Photovoltaic (PV) generation and home load consumption data locally for a temporal length of no less than 24 hours. For each of the 2 curves (PV and home load) as shown in FIG. 4A, calculate the 24-hour bias. The prediction model 302 may add 24 hour-now bias with the trend in the data of 24 hours ahead, forming a prediction of next 24 hours in the future. Alternatively, the stored curves may be used as features, to comprise feature set together with other factors, including but not limited to, ambient temperature, time of the day, weather information, to get consumed by a machine learning model to predict PV generation/load consumption in the future time, for example 24 hours. FIG. 4A illustrates an exemplary schematic representation of an energy storage subsystem (ESS) battery-enabled energy saving/arbitration scenario, in which a battery charging/discharging schema is implemented based on a situation, in accordance with an embodiment of the present disclosure. The system 100 provides WHAT is to be optimized, under each of several scenarios (for example, power arbitration and cost saving for home load when EV-charge occurring and EV charge-not-occurring scenario); and, HOW this objective is optimized, via the control selections (including power source(s), time to start charge, time by which to finish charge, using battery storage, and the like.).

In an embodiment, the role of the power source managing subsystem 104 is to manage the flow of power through the system 100, by sending control signals to the various components it connects to, through inverters or converters. These components include PV panel, EV, ESS battery storage, grid supply, home load, and the like. These components play as sources (PV), or sinks (home load), or roles of the two (EV battery, ESS battery, Grid) with conditions apply. When EV charging is occurring, the planning model 304 may be responsible to implement the charging profile based on EV charging/discharging scenario. It also operates under the direction of the EVSE 108, supporting initiation, monitoring, regulation, and termination of a charging cycle. In an alternate embodiment, when EV charging is not occurring, the planning model 304 operates according to user-provided policies and built-in objectives, such as storing excess PV energy to the battery storage system. The typical objective is to minimize the grid cost.

In FIG. 4A, in the two scenarios above i.e., EV-charging occurring and EV charging not-occurring scenario, the EVSE 108 uses the EV-not-charging as an example, formulating the problem with mathematical description. The EV-charging problem is formulated in the same way, with variables of EV battery operations adding to that. The objective here is to minimize the cost. Apparently, the PV plays role as free and green energy source, while the scheduling of the ESS's role and flow is the options available to optimize. A typical strategy for this scenario (PV-grid-ESS-load) system may be described in FIG. 4A. Further, FIG. 4A shows the typical strategy, which when PV is available, first uses the PV for home load usage and stores the excessive PV to the storage. When PV is not available or not sufficient, consume the energy in the ESS by supporting the home load, which makes cost saving. The approach in FIG. 4A is simple and effective, but not taking the energy price into consideration; also, this passive manner of battery charge/discharge is not aware of the energy usage peak, which may not be enabled for features like peak shaving or energy arbitrage. A power director planning algorithm such as the planning model 304 may be used to transit from the simple cycle of charge (with excessive PV)/discharge (to support load when PV is unavailable), to more potential of energy arbitrage, and cost savings. The planning model 304 also supports smarter charging of EV, and enables fast, economic, and green charging policies for user's choice. To find more potential of a system with PV and ESS and/or EV battery, the mathematical formulation shown below exemplary scenarios.

Without EV connected, the system 100 comprises of grid-PV-load-ESS elements, and ESS is controlled by policies to store and arbitrage home load usage and minimize cost of the grid. The ESS battery simulated to be size of, for example, 20 kwh, or any other capacity of the ESS battery. In an embodiment, several different strategies are used, featuring the difference in conserving the ESS battery's SOC e.g., some priority to be conservative to maintain high ESS SOC, some are aggressive to use more ESS storage for energy cost-saving. On such policy is a basic policy (policy0)—which is used to store excessive PV to ESS battery, and discharge ESS battery whenever there is load needs. Another such policy is a Rest policy (policy-ess-25%/50%/75%) which are based on the basic policy, applying limitation on the ESS discharging, for example, conserving 50% SOC of ESS battery unless there is high reward of discharging (e.g., high grid price). Given the PV-load-price and EV charging event generated, multiple simulated runs are operated, each with one of the no-EV policies mentioned above.

In an exemplary embodiment, with EV connected, the system 100 applies ‘FAST’ charging policy trying to satisfy the charging demand as soon as possible. The grid (AC) charging may be always ON., Further, the PV/ESS storage will both charge EV, if they are available. Furthermore, if ESS has SOC<20%, it will get charged from grid, and start to charge the EV when SOC is back above 20%.

In an embodiment, the charging performance are evaluated in these metrics, namely, the percentage (%) of times that meet the charging demand in required charge time, if not meeting the requirement, how much percentage (%) energy being charged since the connection, compared to the requirement and an average charging speed (in terms of kw) during all charging events.

In an exemplary embodiment, the prediction model 302 may collect power and/or sensor data 306 or use open-source data for PV/load prediction, including but not limited to historical PV generation, historical load consumption, weather information, environmental temperature, panel temperature, date, timestamp, and the like. The collected power and/or sensor data 306 may be stored in the historical buffer 308. In an exemplary embodiment, the prediction model 302 may split the collected power and/or sensor data 306 into train/validation sets, with considerations of balance of dataset from a geographical, temporal, seasonal perspective, and the like. In an exemplary embodiment, the prediction model 302 may build and train models which ingest the inputs and predict PV and load as prediction data 310. Regression/Random Forest models are the major candidates for such prediction models.

In an exemplary embodiment, the prediction model 302 may collect the power and/or sensor data 306, in real-time, by a Wi-Fi connection or sensors, apply the trained model, to generate the predictions in a future time window of hours, upon request by the planning model 304, as shown in FIG. 3B and indicated as ‘A’. The predicted data may be stored as the power source information 312. Based on prediction and energy price stored in the power source information 312, the planning model 304 may schedule operation (ESS charge/discharge, power flow, and the like.), as shown in FIG. 3B and indicated as ‘B’.

### Planning Model 304:

In an exemplary embodiment, by an event-driven (e.g., PV connected, heavy home load connected, price change, and the like.) and at fixed intervals, the planning model 304 may be activated for properly directing the flow. The event-driven calls may be triggered by, but not limited to, fixed interval, major status change e.g., EV charge session start/end, and the like, pre-defined thresholds e.g., state of charge SOC 20% or significant change in PV, load, and the like, expected to be called in minutes/quarters level of frequency such as to fit with typical charging session's duration, to avoid interference with device/hardware controls, and the like.

In an exemplary embodiment, the planning model 304 calls the prediction model 302, to predict future environmental variables such as the PV generation and load consumption, in a window of for example 4 to 24 hours.

In an exemplary embodiment, the prediction model 302 may obtain battery information from connected components. In an exemplary embodiment, the prediction model 302 may obtain the price source information from resources (in memory or requested from an internet connection). Combine all together with the environmental variables. Formulate the optimization problem in the format of equation (2) or (3) as shown below with all the derived variables. Solve the formulated linear optimization problem to maximize the objective. A sequence of P_ess (and P_ev for formulation (3)) as shown below operation may be derived as the optimal. Adopt the first entry of the optimal action sequence. At a next time interval or by a new event, the planning model 304 calls the prediction model 302, to predict future environmental variable such as the PV generation and load consumption, in a window of for example 4 to 24 hours. Further, the problem is solved by sophisticated methods such as simplex algorithm and solver software. The size of the optimization problem (number of operational variables) may increase linearly along with length scheduling period, and the complexity of linear programming algorithm/solvers is polynomial order of the number of the operational variables (and could be worse in certain cases).

Below are some additional customized techniques to simplify the solving process, based on analysis of a specific optimization problem.

### Exemplary Scenario 1:

Consider, scenario of without EV charging in the EVSE 108. For without EV scenario which is a cost-minimization problem, the analysis below depicts the factors to simplify the optimization problem, by trimming the action sequences spanning in a solution space. FIG. 3B illustrates a cost saving approach using the planning model 304 (no EV connected) for an exemplary 12-hour scenario. The indication ‘B’ in the graph of FIG. 3B implies that there is an extreme discharge scenario to support load during the peak energy price hours. The indication ‘C’ in the graph of FIG. 3B implies that there is a charging scenario of the ESS battery when energy price is low, and the indication ‘D’ implies that there is a discharge holding action for potentially higher cost saving (when energy price is even higher). Further, FIG. 3C illustrates an exemplary cost saving scenario using the planning model 304 (no EV connected) for the long term. The indication ‘A’ in the graph of FIG. 3C implies that there are more charge/discharge cycles to utilize the energy price change for cost saving, and indication ‘B’ implies that there is higher potential of cumulative saving due to the inclusion of the power source information 312 (i.e., price information) in the planning scenario. Further, FIG. 3D illustrates an exemplary energy arbitrage scenario with planning (no EV connected) scenario. The indication ‘A’ in the graph of FIG. 3D implies that the power drawn from grid is lower during peak hour on average, with planning capability.

Formulation of without EV charging scenario (PV-ESS-grid-load) for the components the power source managing subsystem 104 connects, without loss of generality, may describe each by parameters as shown in table depicted in FIG. 4B: In an exemplary embodiment, it is assumed that a discrete time domain as segments of a short time period, for example, 15 minutes, and approximately consider the time-dependent variables shown in the table depicted in FIG. 4B is not changed in each time segment. The time segment can be considered as a unit of time, expressed as Ts below.

In an embodiment, for ESS operations, i.e., charging or discharging operations, it can be unified as one signed value, for example, charging ‘−10 kwh’ depicts discharge 10 kwh. With the notations above, for each time segment, equations below can be derived by conservation of energy:

E_{buy}[t]+P_{PV}[t]*Tₛ=P_{ESS}[t]*Tₛ+E_{Sell}[t] equation (1.1)

In the above equation, the E_{buy} is the electricity energy (in kwh) buy from grid, and E_{Sell} is the energy sold to grid. The P_{ESS}, as mentioned above, means charging to the ESS battery if is positive, and discharging from ESS when negative. Hence, the LHS of the equation is the energy, and RHS is energy consumed, stored, or sold. The continuity of the ESS battery storage yields to:

SoC_{ESS}[t]+P_{ESS}**Tₛ=SoC_{ESS}[t+1] equation (1.2)

Further, the power rate of the ESS charging/discharging is subject to limitation of:

−P_{ESS.max.discharge}<P_{ESS}<P_{ESS.max.charge}] equation (1.3)

and the SOC of the ESS battery is subject to its capacity limitation at any time, which means:

0<SoC_{ESS}[t]<SoC_{ESS.Max}

0<SoC_{ESS}[t+1]<SoC_{ESS.Max} equation (1.4)

Further, over a period, the cost over time may be expressed as:

ΣₜCost[t]=Σₜ(E_{buy}[t]*Price_{buy}[t]−E_{Sell}[t]*Price_{Sell}[t]) equation (1.5)

Considering all the equations 1.1 to 1.5 together, an optimization problem may be formulated, which is expressed as:
Minimize subject to:

$${\sum }_{t} Cost [ t ] = {\sum }_{t} ( {E}_{buy} [ t ] * {Price}_{buy} [ t ] - {E}_{Sell} [ t ] * {Price}_{Sell} [ t ] ) , \qquad equation ( 2 )$$

$${E}_{buy} [ t ] + {P}_{PV} [ t ] * {T}_{s} = {P}_{ESS} [ t ] * {T}_{s} + {P}_{Load} [ t ] * {T}_{s} + {E}_{Sell} [ t \}$$

$${SoC}_{ESS} [ t ] + {P}_{ESS} ( t ) * {T}_{s} = {SoC}_{ESS} [ t + 1 ]$$

$$- {P}_{ESS . max . discharge} < {P}_{ESS} [ t ] < {P}_{ESS . max . charge}$$

$$0 < {SoC}_{ESS} [ t ] < {SoC}_{ESS . Max}$$

$$0 < {SoC}_{ESS} [ t + 1 ] < {SoC}_{ESS . Max} ……$$

The operational variable is the NESS, which means the charging/discharging action on the ESS battery (a signed variable, positive for charging, negative for discharging). It also intrinsically contains the choice of the power flow, with its sign as the indicator. The above equations 1.1 to 2 may need to add some parameters to be more practical, for example, the energy transfer should have a loss (i.e., efficiency <100%), efficiency factors should be applied on 1.1, 1.2; the SOC of the battery may not be healthy or practical to go to extreme, and the P_ess_max_charge or discharge may be dependent on its SOC. While in all, these do not change the fundamental of the problem, which is a linear optimization problem, and do not change the structure of the formulation above.

In an exemplary embodiment, the planning model 304 may merge the future window into a small number of temporal blocks. The planning model 304 may be called at fixed time intervals or event driven. The event-driven calls may be triggered by, but not limited to, fixed interval, major status change e.g., EV charge session start/end, and the like, pre-defined thresholds e.g., state of charge SOC 20% or significant change in PV, load, and the like, expected to be called in minutes/quarters level of frequency such as to fit with typical charging session's duration, to avoid interference with device/hardware controls, and the like. The future window variables (both predicted such as the PV, and price) are organized in a fixed time interval too (except for the starting or ending step, which may be partial-length due to event-driven calls).

While for solving the optimization problem, it may not be necessary to stick to a fixed interval representation of the future time window. For charging/discharging operations which are both lossy operations, there may be no benefit of action cycles unless there are price differences. (or there is EV charging demand for with EV charging scenario). Hence, the time window could be grouped into small number of blocks based on price schedules, which leaves, typically, no more than 5 to 6 blocks for an 8-hour window.

Further, consider a 3-stage grid price schedule for action pruning by known priorities. The ESS 114, if ready to discharge, should be consumed by the load as much as it can, during the highest price region. Because this is the way yielding most benefit. Sell-to-grid, in some places, is not available, and at available locations, its price is also likely to get further reduced to make this option less attractive compared to storing excessive energy in the ESS 114 locally then consumed by a house load 316 for cost savings. Also, other heuristic rules for prioritizing source/sinks (house load 316), storage or use-now, can be used for pruning. The above two factors may be suppressed in the solution space, since it reduces the time block numbers (hence reducing the size of the problem), and in each time block step, the action space is also pruned by the known priorities. With further quantization of the charging/discharging action (e.g. (dis)charge at 100% rate/50%/25%/0%), the problem can even be solved by iterative search.

In an exemplary embodiment, the optimization problem can be simplified as discussed below. The planning model 304 generates compact time-block representation of future window data including the predicted variables. Starting from the first-time block, generate state-action rewards (SAR) to describe potential states and rewards (e.g., cost-saving) for each action choice (choices are reduced by the pruning). The planning model 304 may span the SAR from each of the consequential time blocks, till the end of the time window. The planning model 304 may find the path i.e., sequence of actions leads to the optimal results using objective function as a metric.

### Exemplary Scenario 2:

Consider, a scenario of EV charging in the EVSE 108. With EV connected i.e., EV charging, which is the main feature of the system 100, there are three policies available for user to choose from green charging (only charge EV with green (PV) energy as long as the EV battery higher than minimum charge level)), economical charging: ensuring that the EV is charged to meet demanded date, time and range requirements and fast charging, charge as fast as it can

The formulation of equations (3) and (4) below are relatively more complex than formulation (2) without the EV charging scenario with the actionable variable doubled (2 battery). Taking formulations (2) and (3) for comparison, (these two formulations both takes cost minimization as objective so should have more meaningful comparison), the reason behind the mathematics that (3) is harder than (2) is, EV charging is a load with degree of freedom to schedule, and not like the home load (assume that it is kind of ‘mandatory’ load at its time). This degree of freedom makes economy charging mode including space to optimize, but also leaves a harder mathematical formulation to solve. The way to simplify this problem is to consider the problem as load scheduling problem rather than a flow optimization problem. Taking economy charging mode as an example, the steps of solving a load scheduling problem may include, given the demanded EV battery target (i.e., range) and demanded time (to reach the target), the planning model 304 may generate a future window representation with price schedules, segmented by the price changes. Further, the planning model 304 may estimate the charging ability (how much could be charged) in each segment; schedule the charging from the segment with the lowest electricity price. Further, the planning model 304 may populate one or more unoccupied segments in the same way and accumulate the estimated charge, until reaching the target. Further, the EVSE 108 may operate according to the derived schedule (take the resulted action in the 1st time segment) at fixed time interval (such as a smallest charging session time), and/or by event activation, update the demand and EV state and generate a future window representation, estimate charging ability, populate unoccupied segments, and operate according to derived schedule, to adapt to reality. Further, the fast mode may be simplified to maximize the charging speed by one or more automatic cycles (charging to EV—get charged from grid if drained) of the ESS 114. Further, all other power sources 106 (such as the PV, the grid) may support delivering power to the EV.

In an exemplary embodiment, under green charging option, the behavior of the charger is relatively simpler because the flow is directly defined by the policy (PV EV battery; can use other resource if EV battery <minimum range). Further, the objective of ECO charging mode is to include a plurality of possible flow options for both charging demand and cost saving scenario. To depict mathematically, the EV battery's charging demand, and the ability of EV battery as energy storage, are to be added into equation (2). For example, a demand of charging to certain level and being cost-effective, it can be described as equation (3) below. It can be seen the charge demand, and restrictions on EV battery, are added into the formulation, and of course makes the problem more complicated than (2) above. The operational variables now includes both NESS and PV, which indicates all possible combinations of flow direction, and the amount of charge/discharge. In Fast charging mode is also relatively straightforward, however involves the ESS battery's flow options (charging EV or get charged from grid/PV) to maximum the charging speed.

Minimize subject to:

$${\sum }_{t} Cost [ t ] = {\sum }_{t} ( {E}_{buy} [ t ] * {Price}_{buy} [ t ] - {E}_{Sell} [ t ] * {Price}_{Sell} [ t ] ) , \qquad equation ( 3 )$$

$${SOC}_{EV} [ {T}_{charge . session . end} ] \geq {SOC}_{EV - demanded}$$

$${E}_{buy} [ t ] + {P}_{PV} [ t ] * {T}_{s} = {P}_{ESS} [ t ] * {T}_{s} + {P}_{EV} [ t ] * {T}_{s} + {P}_{load} [ t ] * {T}_{s} + {E}_{Sell} [ t ]$$

$${SOC}_{ESS} [ t ] + {P}_{ESS} ( t ) * {T}_{s} = {SoC}_{ESS} [ t + 1 ]$$

$$- {P}_{ESS . max . discharge} < {P}_{ESS} [ t ] < {P}_{ESS . max . charge}$$

$$0 < {SoC}_{ESS} [ t ] < {SoC}_{ESS . Max}$$

$$0 < {SoC}_{ESS} [ t + 1 ] < {SoC}_{ESS . Max}$$

$${SOC}_{EV} [ t ] + {P}_{ESS} ( t ) * {T}_{s} = {SoC}_{EV} [ t + 1 ]$$

$$- {P}_{EV . max . discharge} < {P}_{ESS} [ t ] < {P}_{EV . max . charge}$$

$$0 < {SoC}_{EV} [ t ] < {SoC}_{EV . Max}$$

$$0 < {SoC}_{EV} [ t + 1 ] < {SoC}_{EV . Max} ……$$

For both formulation (2) and (3), they are linear optimization problems (since the objective and the restrictions are all linear expressions).

In an embodiment, analysis of the problem formulation is discussed. The system 100 provides two major models, a prediction model 302 to predict those future variables and a planning (or say optimization) model to find the optimal solution (action sequence) based on the problem parameters predicted. For prediction model 302, building a model to predict future PV generation, load consumption, or EV demands are disclosed. A precise model will be helpful for the whole solution. For example, conventional methods may have reported the PV forecast with weather and location information and applied it in the battery storage control. For planning model 304, to solve a linear optimization problem, some sophisticated tools are to be chosen from, for example, dynamic programming (need to discretize the status), linear programming, and more recently neural networks (NN). These days the end-to-end NN-based reinforcement learning (RL) method is extensively discussed on solving optimization problems and could avoid dividing the problem into prediction/planning 2 models. Instead, the RL takes all available inputs and generates the solved optimal solution in a black-box manner.

In an exemplary embodiment, the system 100 records and analyzes simulation results performed on an EV charging performance parameter, considering a random EV arrival (charge start) time, and a random charging demand (in terms energy to be charged in desired time). This is performed to determine what charging speed could be expected from a hybrid charging system (PV/grid/battery storage), and impact of battery storage on the EV charging performance parameter (for example, to determine whether the target is reached in a demanded time). The outcome provides guidance on the design of the energy management strategy when EV is not charging, for example, the ESS battery storage may be tried to be kept at high SOC (when EV is not connected), to ensure a good or fast charging experience that meets the demand most of time.

In an exemplary embodiment, the system 100 comprises a simulation tool, which comprises of a grid-PV-load system. PV, and load elements are highly abstracted into power values that dynamically change with time, without further details of voltage, current, and the like. All the PV generated power or load power, or grid price schedule time series are from real-world data. Further, the simulation tool comprises an ESS battery for energy storage or demand arbitrage. Also, it is abstracted by typical parameters such as state of charge (SOC), state of health (SOH), charging/discharging power limits, charging/discharging efficiencies. Further, the simulation tool comprises an EV (with its battery) that generates charging demands (and also can serve as battery storage in case).

In an exemplary embodiment, simulations of possible power flow and incurred cost are enabled by the interaction of these elements. Currently, the energy management optimization i.e., power director planning algorithm are developed based on the simulation tool. The system 100 is considered as a fast DC EV charger with a peak charging power of 24.6 kw, which consists of 15 kw from the DC link, either PV source or ESS battery with additional 9.6 kw from the grid i.e., AC source. The latter (9.6 kw AC) can always be available except for the grid outage event. The former is dependent on PV availability and the stored energy in ESS battery. In a scenario, for example, when PV is insufficient, and there is less energy stored in the ESS battery, the charging is solely on the grid supply i.e. 9.6 kw. It may not be rare that user charges the EV during a time that has low PV gain, e.g., when come back home after daytime out. A good prediction model may predict the EV charging demand (or time) well such that the ESS battery could get prepared before, while the prediction is not perfect. Hence, the state of the ESS battery may impact the charging performance in such cases, which determines whether the system 100 (EV charger) performs as a 9.6 kw level 2 charger, or a fast charger with approximately twice the charging power.

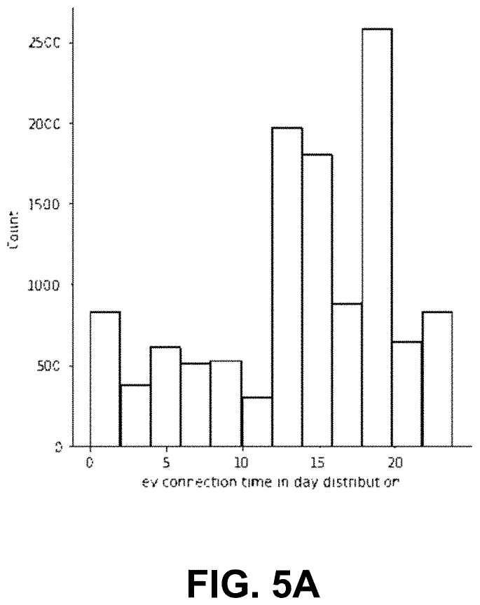

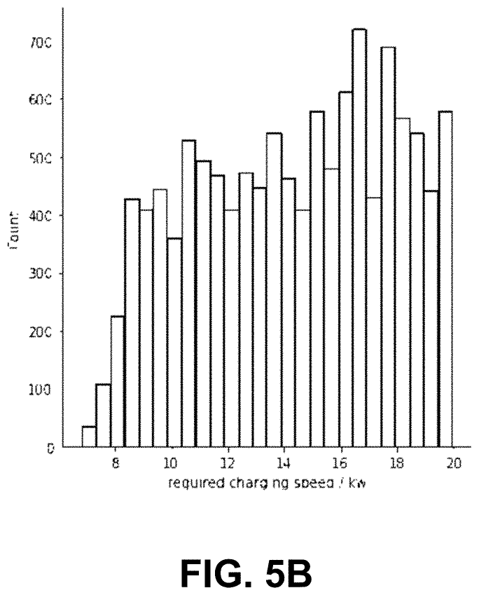

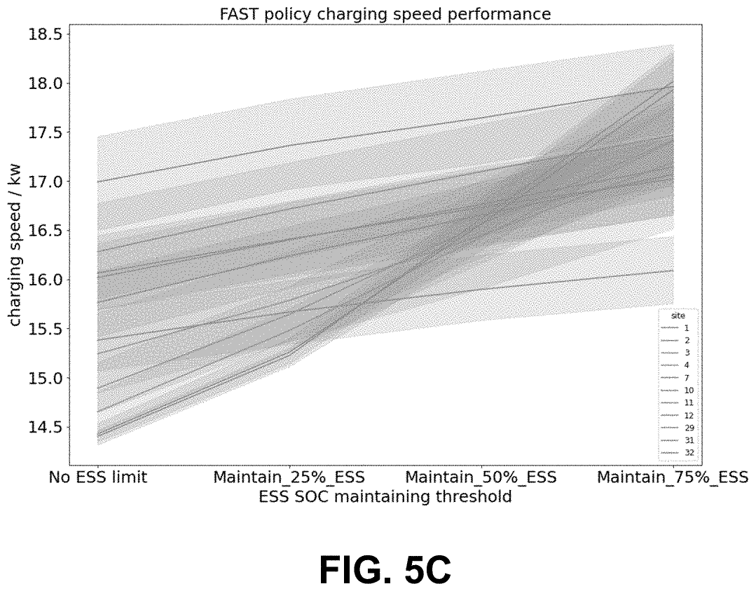

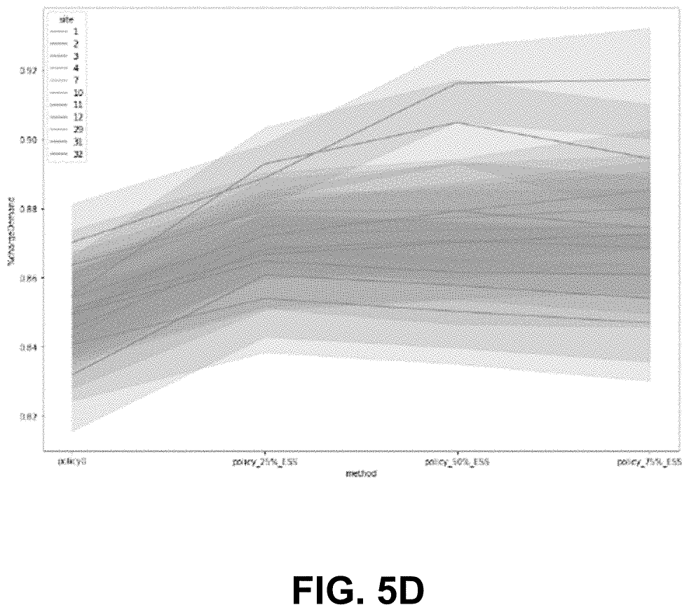

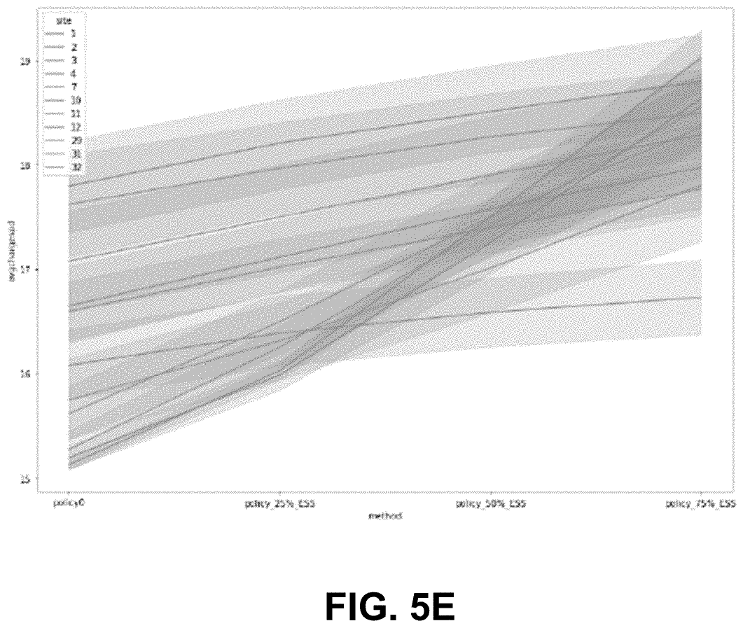

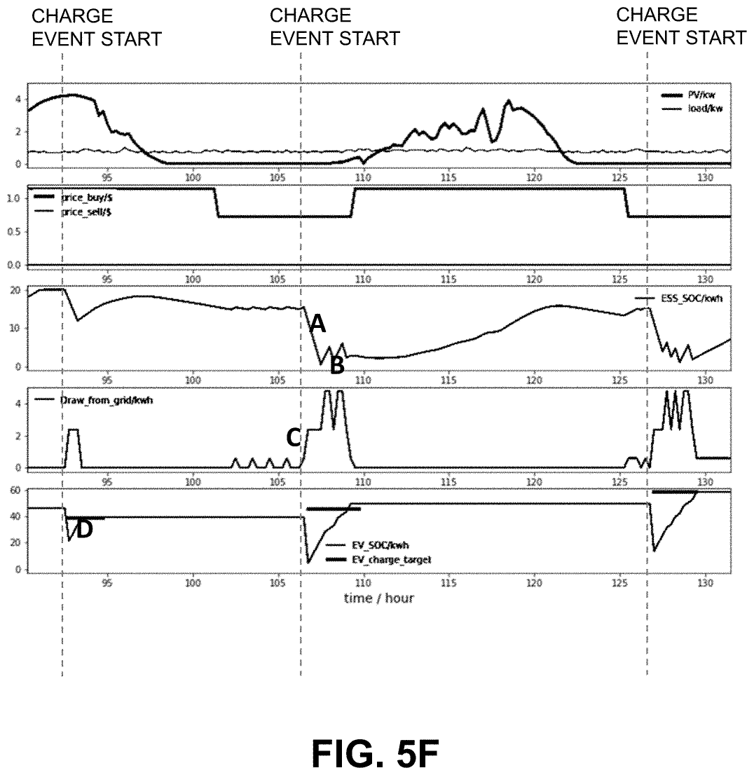

FIG. 5A illustrates an exemplary graphical representation of EV connection time in day distribution, in accordance with an embodiment of the present disclosure. In FIG. 5A, a simulated EV connection time is determined. The EV connection (start charging time) is randomly sampled over 24 hours in a day, with higher weights in some part of the day, e.g., time after work. The distribution is shown in FIG. 5A.

FIG. 5B illustrates an exemplary graphical representation of required charging speed/kw, in accordance with an embodiment of the present disclosure. In FIG. 5B, a simulated EV charging demand per visit is determined. The charging demand is represented as X kwh over Y hours, both X and Y are randomly sampled from reasonable range. To abstract and show the charging demands variation, the demanded charging speed is calculated by X/Y, and its distribution is shown in FIG. 5B. The demanded charging speed is spanning within 7 to 20+ kw, which will be reasonable for the system 100 as a charger capable of 9.6-24.6 kw charging.

FIG. 5C illustrates an exemplary graphical representation of state of the ESS battery impacting the charging performance when meeting the charging demand in required time, in accordance with an embodiment of the present disclosure. In FIG. 5C, the state of the ESS battery (how much SOC being ready for discharge) which impacts the charging performance in terms of meeting the user's requirement is depicted. Apparently, a management policy that maintains the ESS SOC at a higher level will have better performance.

FIG. 5D illustrates an exemplary graphical representation of state of the ESS battery impacting the charging performance when energy being charged within required time compared to required amount is not meeting requirement, in accordance with an embodiment of the present disclosure.

FIG. 5E illustrates an exemplary graphical representation of average charging speed (kw) during the charging events, in accordance with an embodiment of the present disclosure. In FIG. 5E, it is observed that the management policy that maintains the ESS SOC at higher level leads to higher charging speed on average.

In an exemplary embodiment, it can be concluded that solution is utilizing a simulation tool of EV charging events, and checking the potential performance of charging to see if that can meet user's expectations (as an EV charger of better than 9.6 kw charging speed). Some observations of the simulation results are given here. Firstly, using the management policies (no-EV case) may maintain the ESS SoC at certain level, to ensure the system 100 may well meet the user's demand at a high expectation. In the simulation, the EV charging is using ‘FAST’ mode which means the power director will try fastest way possible to charge the EV. From the figures, it can be seen that the average charging speed is around 15+ kw even under the basic policy and no guaranteed EV availability. This is because the ESS battery is performing charge-from-grid/feed-to-EV operation cycles (at speeds of 9.6 kw, 15 kw, respectively), which leads to, approximately, 15 kw*9.6/24.6+9.6 kw=15.45 kw charging speed. FIG. 5F illustrates an exemplary fast EV charging scenario. The indications ‘A’ and ‘C’ in the graph of FIG. 5F implies that the charging to EV battery is from both grid and the ESS battery, the indication ‘B’ implies that to start ESS charge (from grid)/discharge (to EV) cycles to support fast charging demand, and the indication ‘D’ implies a charging target. In fast charging mode, maximum charging as fast as possible is provided to EV battery. The planning model 304 signals ESS charge to EV battery, as supplementary of grid AC charging. When ESS SOC drained to certain level, the planning model 304 signals the charge (from grid)/discharge (to EV) cycles on ESS.

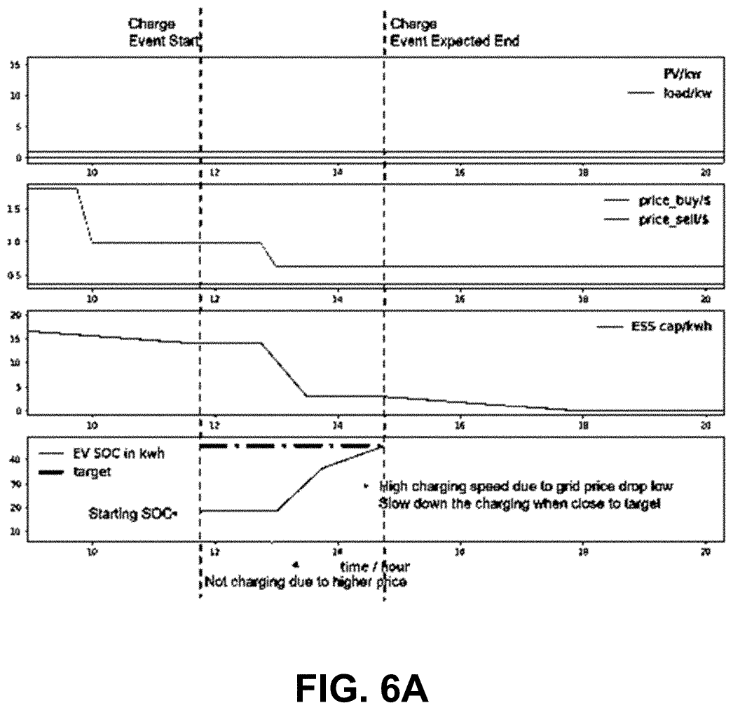

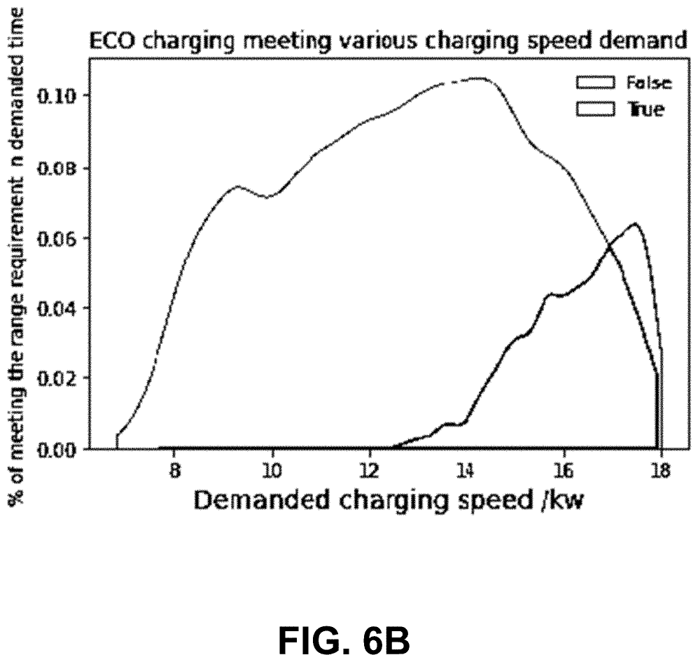

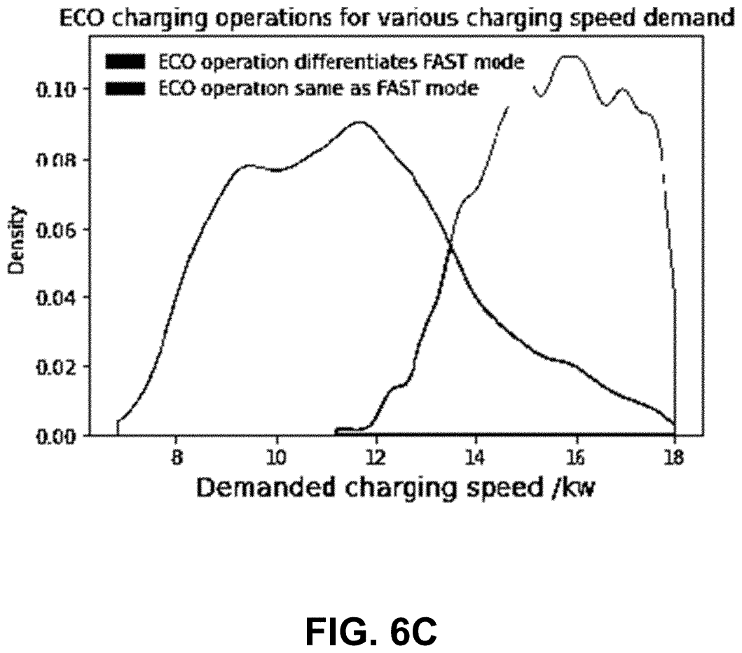

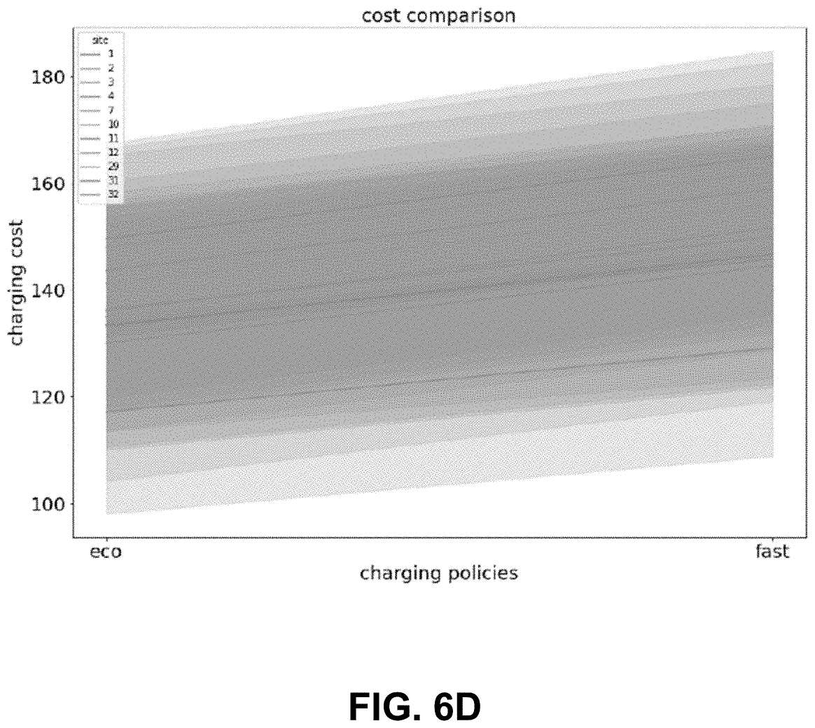

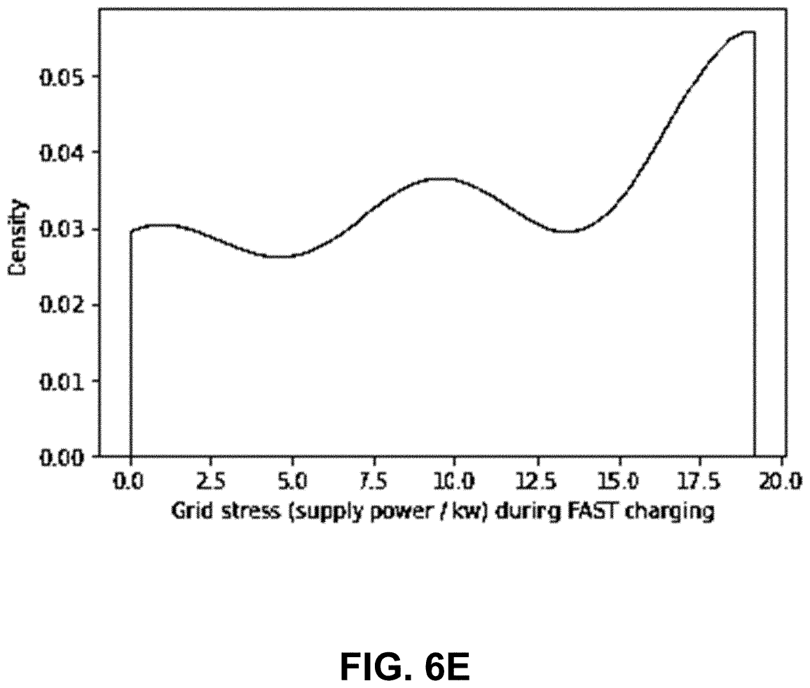

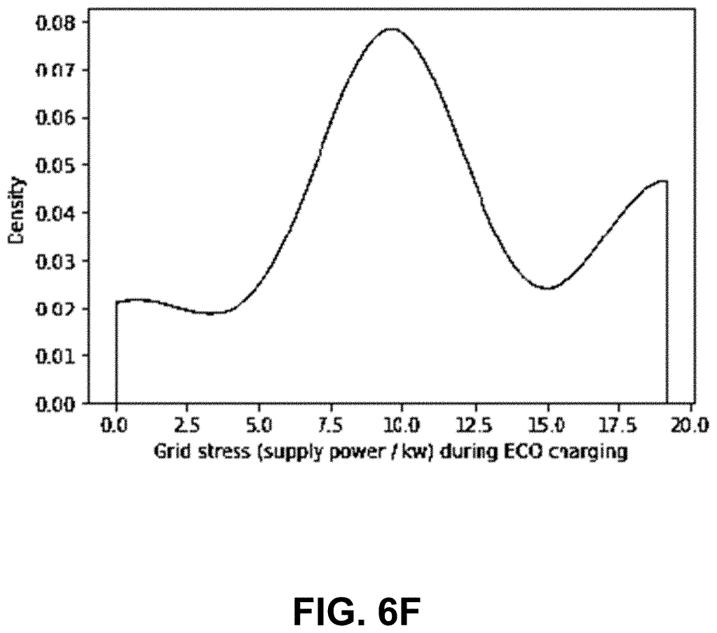

FIG. 6A illustrates an exemplary timing diagram representation of a charging event during load scheduling for economical charging policy, in accordance with an embodiment of the present disclosure. In an embodiment, the system 100 discloses a predictive load-scheduling method, used for the Economical charging policy, with the ability of achieving charging demand within desired time, in a cost-effective way. The system 100 also describes a method, to answer the question about ECO policy, that “when user demands charging X kwh within time of Y, what is the reasonable range of X given the time Y?” Reasonable refers to when the target X is achievable by the charger within time Y with ECO policy. There is space for power director to perform cost optimization.

In an embodiment, the ECO charging policy of the system 100 (EV charger), is described as economical charging, where energy is provided from the EV to the house, while still ensuring that the EV will be charged according to the date, time and range requirements. Further, compared to ‘Green’ and ‘Fast’ policy, the ‘date, time and range requirements’ is exclusive for ECO policy, which is its main feature. Here, it is interpreted that the user specifies a timed charging target, i.e., charge X kwh in the next Y hours' time, and ECO policy is to fulfill this demand with cost-effectiveness. Below, a load-scheduling method is disclosed, and simulations to verify the performance.

In an embodiment, the ECO policy with a timed charging demand is more like a load scheduling problem. Further, the system 100 is dealing with, the home-load grid cost optimization, although they both take costs as major optimization objective, there is an essential difference here: The power director is not expected to schedule the house-utility's on/off, while with the ECO charging, the planning model 304 has ability and is expected to schedule the charging load. Hence, the former problem can be formulated as power flow optimization, while load scheduling is more suitable for the latter (ECO charging). A load scheduling algorithm is disclosed. This method minimizes the charging cost, especially when there are grid price changes during some time of the day. For the charging events, charging events starting time is sampled randomly. This is to testify the ECO charging behavior responsively. The charging demand i.e., charge X kwh in Y hours: Y is randomly sampled from 2 to 8 hours. X is sampled from 30% to 100% of the EV battery capacity (assumed to be 65 kwh). Further, the ESS battery capacity is chosen to be 20 kwh.

In this method, optimized charging load scheduling is based on grid price. FIG. 6A is an example of a charging event visualized. The x axis is time in hour. The sub-charts may include PV generation power and load consumption power (in kw), the grid price (the buying prices changes during the day), the SOC (in kwh) of ESS storage battery, and the SOC (in kwh) of EV battery. From the visualization, it can be observed that the load scheduling method purposely delayed the charging activity (i.e., not starting from the beginning of the connection), because of the consideration of the cost optimization. This behavior is constantly observed when there are price variations during the desired charging time.

FIG. 6B illustrates an exemplary graphical diagram representation of ECO charging meeting various charging speed demands, in accordance with an embodiment of the present disclosure. In an embodiment, multiple simulation runs are operated with various site data (PV, load, price) configuration and charging events with randomly sampled charging needs (X kwh in Y hour). The density plot of meeting/not meeting charging demands among all charging events are plotted, the x axis is the demanded charging speed. It can be seen that when demanded charging speed (X/Y)<12 kw the ECO policy has no issue with meeting it. And in most cases, the ECO policy could meet the demanded charging (check the yellow area much larger than the blue one). When required higher charging speed (e.g. >14 kw), the ECO policy starts to has failures to meet those demands. Some rationales of the reasons are provided here. The ECO policy progressively estimates how much charging load are needed to be allocated in the following time. As pure-free resource, the PV is always considered as 1st prioritized source for charging. An imperfect PV availability prediction (e.g., PV less sufficient than predicted) could result in an under-estimate of the future charging load needs, which leads to not meeting the demand in time.

FIG. 6C illustrates an exemplary graphical diagram representation of a comparative study charging demand suitable for ECO policy/mode, in accordance with an embodiment of the present disclosure. According to the simulation, the FAST policy, when under the adverse situation (no PV availability, no ESS stored energy), can ensure a charging speed of about 14 kw. The ECO policy, given the user demand, plans the charging the same way FAST policy do if need to, while losing flexibility due to the prompt demand. It is interesting to find out, what is the range of charging needs (in terms of charging speed kw, i.e., demand charging X kwh/demanded time Y hour) that is suitable for ECO policy, being achievable of the target, meanwhile differentiates with FAST policy. To tackle this question, multiple simulation runs are operated with various site data (pv, load, price) configuration and charging events with randomly sampled charging needs (X kwh in Y hour). The charging actions are determined by the ECO mode load scheduling method of the power director. If the charging action with the ECO mode is same as FAST mode, it should be due to the very prompt demand. To interpret FIG. 6C, the blue area corresponds to the distribution of demanded charging speeds, among the charging events, that the charge action under ECO mode differentiates with FAST mode (i.e. the power director has flexibility to plan the charging load in desired time, to lower the cost/lower the grid instant demand). The red area is vice versa. In these charging events, the ECO mode has no flexibility but only has to charge like FAST mode. From FIG. 6C, it can be observed that, when the demanded charging speed <12 kw, (X/Y<12), the power director's ECO mode (with load scheduling method) almost always has way to arbitrage the charging schedule, for a better cost saving, or lower the grid stress. while when charging speed >14 kw, the charging action are more likely to be same as FAST mode, it's no longer meaningful to provide 2 options (Fast, Eco) to user under such case (because they behave the same).

FIG. 6D illustrates an exemplary graphical diagram representation depicting a ECO and FAST charging cost, grid-stress comparison, in accordance with an embodiment of the present disclosure. The system 100 is designed to study the difference in the charging costs between ECO and FAST charging. For each simulated run, a 7-day period sampled from various site datasets (PV, load, grid price). On each charging site, an EV arrival/charging-demand schedule is generated and tied to this 7-day period, at the frequency of about 1 charging event a day. Two simulated runs sharing the configuration settings above. ECO and FAST charging are adopted respectively for each of the 2 runs. The average charging_costs are compared (calculated by the total_cost−cost_on_house_load) between the 2 policies. In this embodiment, the cost here is dependent on the actual price of the site (the price data gets normalized to be 1$/kwh as mean value), grid price, variability, PV availability, the simulated EV charging demands, and the like, hence the exact number of the costs are only meaningful for this simulation. Here, it is to show that the ECO policy, as expected, leads to lower costs than FAST policy.

FIGS. 6E and 6F illustrate exemplary graphical diagram representations of grid supply power (/kw) during FAST and ECO charging, in accordance with an embodiment of the present disclosure. From the same simulated runs, the grid stress comparison is also made for the two policies. The grid stress is interpreted to be the grid supply power (/kw) during the charging events. The distribution (density plot) of the grid supply power value is generated based on all charging events simulated on various data configuration, for ECO and FAST policies, respectively. It can be seen that, by using ECO charging policy, the grid stress during all charging events is centered around 10 kw (actually 9.6 kw, which is the AC-to-EV charging rate). For FAST policy, the stress on the grid is apparently skewed to high values, due to the need of charging both ESS and EV (for the purpose of allowing DC+AC charging to EV later). The behavior shown agrees with expectation.

From this analysis, the system 100 suggests that when user plugged in the EV and start to select the ECO mode and specify the X (demanded charge range)/Y (demanded charge time) values, some GUI may limit or highlight the user's inputs on X, Y combinations, (e.g., suggest fast policy when user require X/Y>13 kw) that gives user expectations of when ECO policy could shine, and suggests better way of using ECO policy. From the simulated results, the ECO policy does differentiate from FAST policy from the cost, grid-stress perspective.

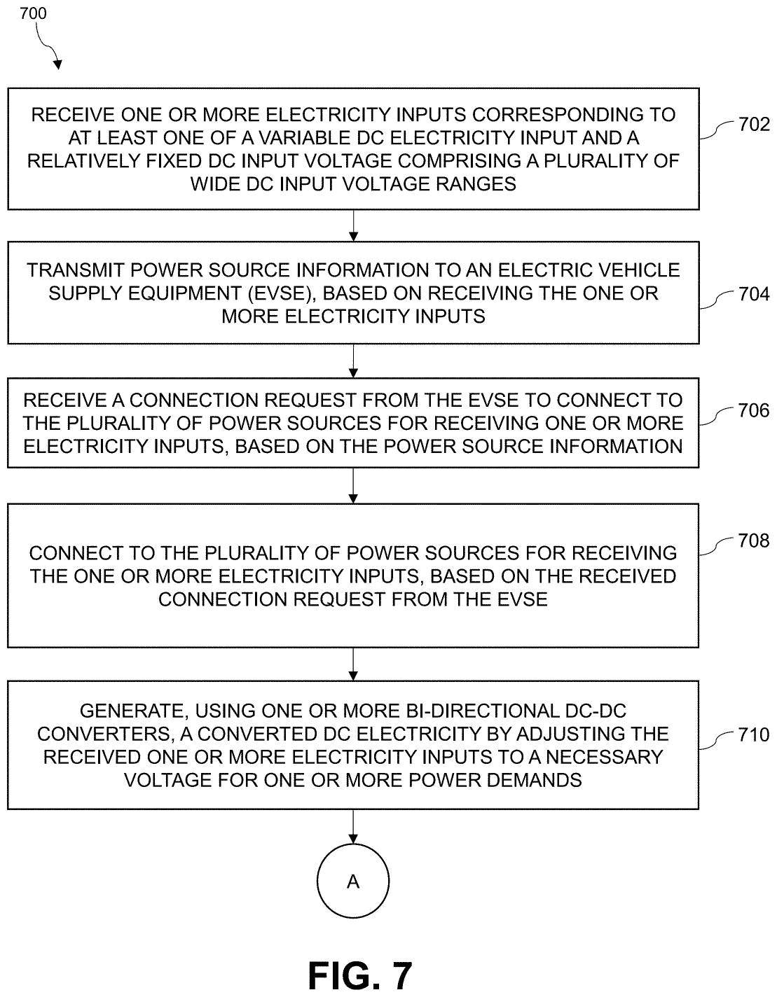

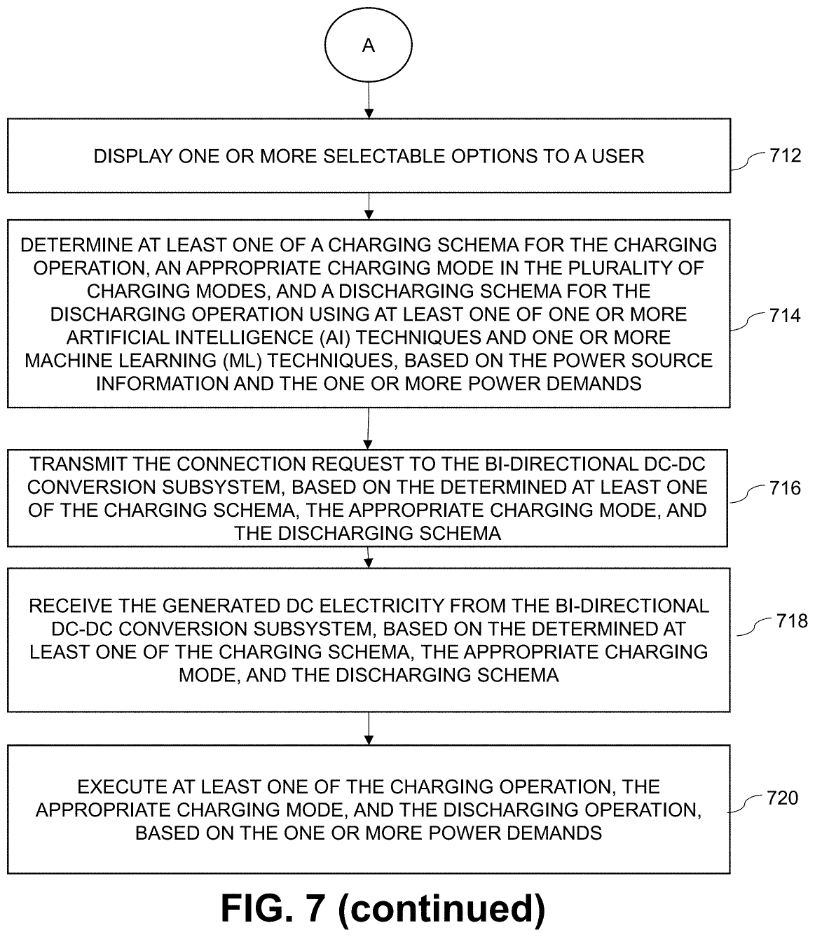

FIG. 7 illustrates an exemplary flow diagram representation of a method 700 for a bi-directional direct current (DC) charging in an electric vehicle supply equipment (EVSE), in accordance with an embodiment of the present disclosure.

At step 702, the method 700 may include receiving, from the power source managing subsystem 104 associated with a bi-directional direct current (DC)-to-DC conversion subsystem 102, via a plurality of power sources 106, one or more electricity inputs corresponding to at least one of a variable DC electricity input and a relatively fixed DC input voltage comprising a plurality of wide DC input voltage ranges.

At step 704, the method 700 may include transmitting, by the bi-directional direct current DC-DC conversion subsystem, power source information to an electric vehicle supply equipment (EVSE), based on receiving the one or more electricity inputs.

At step 706, the method 700 may include receiving, by the bi-directional direct current DC-DC conversion subsystem, a connection request from the EVSE to connect to the plurality of power sources for receiving one or more electricity inputs, based on the power source information, wherein the connection request comprises at least one of a required one or more electricity inputs from the plurality of power sources and a required voltage for one or more power demands by one or more power demanding equipment.

At step 708, the method 700 may include connecting, by the bi-directional direct current DC-DC conversion subsystem, to the plurality of power sources for receiving the one or more electricity inputs, based on the received connection request from the EVSE.

At step 710, the method 700 may include generating, by the bi-directional direct current DC-DC conversion subsystem, using one or more bi-directional DC-DC converters, a converted DC electricity by adjusting the received one or more electricity inputs to a necessary voltage for one or more power demands.

At step 712, the method 700 may include displaying, via a user interface associated with the EVSE communicatively coupled to the bi-directional DC-DC conversion subsystem, one or more selectable options to a user, wherein the one or more selectable options comprising at least one of a charging operation, a discharging operation, and a plurality of charging modes.

At step 714, the method 700 may include determining, by the EVSE, in response to a selected one or more selectable options, at least one of a charging schema for the charging operation, an appropriate charging mode in the plurality of charging modes, and a discharging schema for the discharging operation using at least one of one or more artificial intelligence (AI) techniques and one or more machine learning (ML) techniques, based on the power source information and the one or more power demands. The appropriate charging mode is determined based on the power source information.

At step 716, the method 700 may include transmitting, by the EVSE, upon receiving the power source information from the bi-directional DC-DC conversion subsystem, the connection request to the bi-directional DC-DC conversion subsystem, based on the determined at least one of the charging schema, the appropriate charging mode, and the discharging schema.

At step 718, the method 700 may include receiving, by the EVSE, in response to the connection request, the generated DC electricity from the bi-directional DC-DC conversion subsystem, based on the determined at least one of the charging schema, the appropriate charging mode, and the discharging schema.

At step 720, the method 700 may include executing, by the EVSE, upon receiving the generated DC electricity, at least one of the charging operation, the appropriate charging mode, and the discharging operation, based on the one or more power demands.

The order in which the method 700 is described is not intended to be construed as a limitation, and any number of the described method blocks may be combined or otherwise performed in any order to implement the method 700 or an alternate method. Additionally, individual blocks may be deleted from the method 700 without departing from the spirit and scope of the present disclosure described herein. Furthermore, the method 700 may be implemented in any suitable hardware, software, firmware, or a combination thereof, that exists in the related art or that is later developed. The method 700 describes, without limitation, the implementation of the system 100. A person of skill in the art will understand that method 700 may be modified appropriately for implementation in various manners without departing from the scope and spirit of the disclosure.

Embodiments of the present disclosure provide a system and a method for a bi-directional direct current (DC) charging in an electric vehicle supply equipment (EVSE). In general, the embodiments provided herein relate to managing electric energy flow or power among different electric energy sources, for charging an electric vehicle and/or delivering power to one of the energy sources from one or more of the other energy sources, and/or delivering power to a house load from different electric energy sources. The present disclosure provides a system and method for accepting a variable DC voltage input rather than a fixed DC voltage input. The variable DC voltage input can vary over time or can accept a relatively fixed DC input with a wide range of input DC voltages, or both. The present disclosure provides a system and a method for adjusting, by an electric vehicle supply equipment (EVSE), the voltage internally to meet the charge voltage(s) supported by any respective connected electric vehicle (EV) or a house load. The present disclosure allows user to interact with the EVSE to select from what sources and when charging/discharging would take place, and these selections can be communicated to a power source managing subsystem. These control selections can include power source(s), time to start charge, time by which to finish charge, et cetera. These types of control selections can provide different charging modes which are selectable by the individual with the EVSE, either directly or by a communicating software application. The present disclosure optimizes charging load scheduling based on a grid price. The present disclosure ensures planning the charging and ensures the target is met in desired time. The present disclosure minimizes the charging cost, especially when there are grid price changes during some time of the day. Further, the present disclosure ensures planning of a typical strategy for (photovoltaic (PV)-grid-energy storage subsystem (ESS)-house load) system scenario.

One of ordinary skill in the art will appreciate that techniques consistent with the present disclosure are applicable in other contexts as well without departing from the scope of the disclosure.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, and the like. of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A system for bi-directional direct current (DC) charging in electric vehicle supply equipment (EVSE), the system comprising:
a bi-directional DC-to-DC conversion subsystem, communicatively coupled to a power source managing subsystem, configured to:
receive, from the power source managing subsystem, via a plurality of power sources, one or more electricity inputs corresponding to at least one of a variable DC electricity input and a relatively fixed DC input voltage comprising a plurality of wide DC input voltage ranges;
transmit power source information to an electric vehicle supply equipment, based on receiving the one or more electricity inputs;
receive a connection request from the EVSE to connect to the plurality of power sources for receiving the one or more electricity inputs, based on the power source information, wherein the connection request comprises at least one of a required one or more electricity inputs from the plurality of power sources and a required voltage for one or more power demands by one or more power demanding equipment;
connect to the plurality of power sources for receiving the one or more electricity inputs, based on the received connection request from the EVSE; and
generate, using one or more bi-directional DC-DC converters, a converted DC electricity by adjusting the received one or more electricity inputs to a necessary voltage for one or more power demands; and
the EVSE, communicatively coupled to the bi-directional DC-DC conversion subsystem, configured to:
display, via a user interface associated with the EVSE, one or more selectable options to a user, wherein the one or more selectable options comprises at least one of a charging operation, a discharging operation, and a plurality of charging modes;
determine, in response to a selected one or more selectable options, at least one of a charging schema for the charging operation, an appropriate charging mode in the plurality of charging modes, and a discharging schema for the discharging operation using at least one of one or more artificial intelligence (AI) techniques and one or more machine learning (ML) techniques, based on the power source information, and the one or more power demands;
transmit, upon receiving the power source information from the bi-directional DC-DC conversion subsystem, the connection request to the bi-directional DC-DC conversion subsystem, based on the determined at least one of the charging schema, the appropriate charging mode, and the discharging schema;
receive, in response to the connection request, the generated DC electricity from the bi-directional DC-DC conversion subsystem, based on the determined at least one of the charging schema, the appropriate charging mode, and the discharging schema; and
execute, upon receiving the generated DC electricity, at least one of the charging operation, the appropriate charging mode, and the discharging operation, based on the one or more power demands.

2. The system of claim 1 further comprising:
an energy storage subsystem (ESS), communicatively coupled to the EVSE, configured to:
receive at least one of one or more energy inputs from one or more energy sources and the one or more electricity inputs form the one or more power sources, based on the charging schema;
store the received at least one of the one or more energy inputs and the one or more electricity inputs; and
transmit to the EVSE, the stored at least one of the one or more energy inputs and the one or more electricity inputs, based on the discharging schema.

3. The system of claim 1, wherein the plurality of power sources comprises at least one of a breaker-box connected to an electricity grid, one or more energy storage subsystem (ESS) sources comprising at least one of electro-chemical batteries, a kinetic storage, and a gravitational storage, and one or more renewable energy sources comprising at least one of a photovoltaic (PV) solar energy source, and a wind energy source.

4. The system of claim 1, wherein the power source information is comprised of at least one of a type of each of the plurality of power sources, one or more electricity inputs received from each of the plurality of power sources, one or more voltage ranges of the one or more electricity inputs, a capacity of each of the plurality of power sources, other loads which is supplied by the power source managing subsystem, current and future power pricing data, electrical grid demand response data, and current or future power source capacity data.

5. The system of claim 1, wherein the one or more bi-directional DC-DC converters comprises at least one of: a capacitor-inductor-inductor-capacitor (CLLC) based DC-DC converter, a capacitor-inductor-inductor-inductor-capacitor (CLLLC) based DC-DC converter, a dual active bridge (DAB) based DC-DC converter, a buck based DC-DC converter, a buck-boost based DC-DC converter, a power factor correction (PFC) inverter based DC-DC converter, a PFC rectifier based DC-DC converter, and an electromagnetic interference (EMI) filter based DC-DC converter.

6. The system of claim 1, wherein the one or more selectable options further comprises a preference of each of the plurality of power sources, a period of charging operation, and a period of discharging operation.

7. The system of claim 1, wherein the charging operation is comprised of at least one of: charging a battery pack configured to power an electric vehicle (EV) and charging an energy storage unit associated with an energy storage subsystem (ESS) communicatively coupled to the EVSE, based on the charging schema.

8. The system of claim 1, wherein the discharging operation comprises discharging the energy storage associated with an energy storage subsystem (ESS) to power a house load, based on the discharging schema.

9. The system of claim 1, wherein the plurality of charging modes is used for charging the battery pack configured to power the electric vehicle (EV), and wherein the plurality of charging modes comprises at least one of a renewable charging mode, a green charging mode, a fast-charging mode, an economy charging mode, a time-based charging mode, and a capacity-based charging mode.

10. The system of claim 9, wherein the renewable charging mode uses one or more available renewable energy sources from the plurality of power sources, wherein the green charging mode uses at least one of the one or more renewable energy sources and one or more energy storage subsystem (ESS) sources, wherein the fast charging mode uses a maximum energy from each of the plurality of power sources to charge the EV in a short period, wherein the economy charging mode is used for the charging operation based on a lowest energy cost mixture of the plurality of power sources, wherein the time-based charging mode uses an efficient and cost-effective power sources to charge the EV to a certain capacity by a certain time, and wherein the capacity-based charging mode uses an efficient and cost-effective power sources to charge the EV to a pre-determined capacity.

11. The system of claim 1, wherein the appropriate charging mode is determined based on the power source information.

12. A method for a bi-directional direct current (DC) charging in an electric vehicle supply equipment (EVSE), the method comprising:
receiving, from a power source managing subsystem associated with a bi-directional DC-to-DC conversion subsystem, via a plurality of power sources, one or more electricity inputs corresponding to at least one of a variable DC electricity input and a relatively fixed DC input voltage comprising a plurality of wide DC input voltage ranges;
transmitting, by the bi-directional direct current DC-DC conversion subsystem, power source information to the EVSE, based on receiving the one or more electricity inputs;
receiving, by the bi-directional direct current DC-DC conversion subsystem, a connection request from the EVSE to connect to the plurality of power sources for receiving one or more electricity inputs, based on the power source information, wherein the connection request comprises at least one of a required one or more electricity inputs from the plurality of power sources and a required voltage for one or more power demands by one or more power demanding equipment;
connecting, by the bi-directional direct current DC-DC conversion subsystem, to the plurality of power sources for receiving the one or more electricity inputs, based on the received connection request from the EVSE;
generating, by the bi-directional direct current DC-DC conversion subsystem, using one or more bi-directional DC-DC converters, a converted DC electricity by adjusting the received one or more electricity inputs to a necessary voltage for one or more power demands;
displaying, via a user interface associated with the EVSE communicatively coupled to the bi-directional DC-DC conversion subsystem, one or more selectable options to a user, wherein the one or more selectable options comprises at least one of a charging operation, a discharging operation, and a plurality of charging modes;
determining, by the EVSE, in response to a selected one or more selectable options, at least one of a charging schema for the charging operation, an appropriate charging mode in the plurality of charging modes, and a discharging schema for the discharging operation using at least one of one or more artificial intelligence (AI) techniques and one or more machine learning (ML) techniques, based on the power source information and the one or more power demands, wherein the appropriate charging mode is determined based on the power source information;
transmitting, by the EVSE, upon receiving the power source information from the bi-directional DC-DC conversion subsystem, the connection request to the bi-directional DC-DC conversion subsystem, based on the determined at least one of the charging schema, the appropriate charging mode, and the discharging schema;
receiving, by the EVSE, in response to the connection request, the generated DC electricity from the bi-directional DC-DC conversion subsystem, based on the determined at least one of the charging schema, the appropriate charging mode, and the discharging schema; and
executing, by the EVSE, upon receiving the generated DC electricity, at least one of the charging operation, the appropriate charging mode, and the discharging operation, based on the one or more power demands.

13. The method of claim 12 further comprises:
receiving, by an energy storage subsystem (ESS) communicatively coupled to the EVSE, at least one of one or more energy inputs from one or more energy sources and the one or more electricity inputs form the one or more power sources, based on the charging schema;
storing, by the ESS, the received at least one of the one or more energy inputs and the one or more electricity inputs; and
transmitting, by the ESS, to the EVSE, the stored at least one of the one or more energy inputs and the one or more electricity inputs, based on the discharging schema.

14. The method of claim 12, wherein the plurality of power sources comprises at least one of a breaker-box connected to an electricity grid, one or more energy storage subsystem (ESS) sources comprising at least one of electro-chemical batteries, a kinetic storage, and a gravitational storage, and one or more renewable energy sources comprising at least one of a photovoltaic (PV) solar energy source, and a wind energy source.

15. The method of claim 12, wherein the power source information comprises at least one of a type of each of the plurality of power sources, one or more electricity inputs received from each of the plurality of power sources, one or more voltage ranges of the one or more electricity inputs, a capacity of each of the plurality of power sources, other loads which is supplied by the power source managing subsystem, current and future power pricing data, electrical grid demand response data, and current or future power source capacity data.

16. The method of claim 12, wherein the one or more selectable options further comprises a preference of each of the plurality of power sources, a period of charging operation, and a period of discharging operation.

17. The method of claim 12, wherein the charging operation comprises at least one of: charging a battery pack configured to power an electric vehicle (EV) and charging an energy storage unit associated with an energy storage subsystem (ESS) communicatively coupled to the EVSE, based on the charging schema.

18. The method of claim 12, wherein the discharging operation comprises discharging the energy storage associated with the ESS to power a house load, based on the discharging schema.

19. The method of claim 12, wherein the plurality of charging modes is used for charging the battery pack configured to power an electric vehicle (EV), and wherein the plurality of charging modes comprises at least one of a renewable charging mode, a green charging mode, a fast-charging mode, an economy charging mode, a time-based charging mode, and a capacity-based charging mode.

20. The method of claim 19, wherein the renewable charging mode uses one or more available renewable energy sources from the plurality of power sources, wherein the green charging mode uses at least one of the one or more renewable energy sources and one or more energy storage subsystem (ESS) sources, wherein the fast charging mode uses a maximum energy from each of the plurality of power sources to charge the EV in a short period, wherein the economy charging mode is used for the charging operation based on a lowest energy cost mixture of the plurality of power sources, wherein the time-based charging mode uses an efficient and cost-effective power sources to charge the EV to a certain capacity by a certain time, and wherein the capacity-based charging mode uses an efficient and cost-effective power sources to charge the EV to a pre-determined capacity.
